(19) United States
(12) Patent Application Publication
(10) Pub. No.: US 2024/0119191 A1
(43) Pub. Date: Apr. 11, 2024

(54) GENERATING COOLING CHANNELS FOR COOLING MOLDS

(71) Applicant: Autodesk, Inc., San Francisco, CA (US)

(72) Inventors: Lihao Liang, Portland, OR (US); Clinton van Lingen Kietzmann, Bayswater North (AU); Nikola Marko Markovic, Coulsdon (GB); Akmal Ariff Bin Abu Bakar, London (GB); David Ross Astbury, Boronia (AU)

(21) Appl. No.: 17/958,157

(22) Filed: Sep. 30, 2022

(51) Int. Cl. G06F 30/17

(52) U.S. Cl. CPC G06F 30/17

(57) ABSTRACT

A three-dimensional discretized computer model of a part in a three-dimensional discretized design space comprising three-dimensional geometrical elements is obtained. A signed distance field based on a geometry of the three-dimensional discretized computer model of the part as represented in the three-dimensional geometrical elements of the three-dimensional discretized design space is produced. At least one non-branching cooling channel in a portion of the three-dimensional discretized design space is generated.

### TECHNICAL FIELD

This specification relates to computer aided design and manufacture of molds for molding applications, e.g., injection molding, and in particular to repositioning and/or generating one or more cooling channels in a conformal cooling mold.

### BACKGROUND

In various industries, injection molds are used to manufacture parts, where a cavity of the mold receives a liquid (e.g., plastic resin, metal, etc.) that is solidified in the mold to form the part. The cavity of the mold has a shape corresponding to the part to be manufactured, and other components often include a mold core that fits into the cavity and a clamp that attaches to the mold to produce an appropriate amount of pressure on the liquid in the mold cavity as the liquid is solidified. In addition, some molds have associated cooling channels (pipes or channels) that guide a cooling fluid in proximity to the mold cavity to assist in solidifying the liquid.

Molds have been designed for manufacture by additive manufacturing techniques (i.e., using various 3D printing technologies). In addition, some molds integrate the cooling channels into the mold itself, thereby creating a conformal cooling mold. For example, a mold defining both a cavity of the mold and cooling channels for the mold can be manufactured as a single part using additive manufacturing techniques, which can facilitate putting the cooling channels closer to the liquid to be cooled.

### SUMMARY

This disclosure describes technologies relating to computer aided design and manufacture of molds for molding applications, e.g., injection molding, and in particular to repositioning and/or generating one or more cooling channels in a conformal cooling mold.

In general, one or more aspects of the subject matter described in this specification can be embodied in one or more methods (and also one or more non-transitory computer-readable mediums tangibly encoding a computer program operable to cause a data processing apparatus to perform operations) that include obtaining a three-dimensional discretized computer model of a part in a three-dimensional discretized design space comprising three-dimensional geometrical elements; producing a signed distance field based on a geometry of the three-dimensional discretized computer model of the part as represented in the three-dimensional geometrical elements of the three-dimensional discretized design space; and generating at least one non-branching cooling channel in a portion of the three-dimensional discretized design space using at least one predefined pattern and the signed distance field.

One or more aspects of the subject matter described in this specification can also be embodied in one or more systems including one or more processors; and a computer-readable medium storing instructions that cause the one or more processors to perform operations including obtaining a three-dimensional discretized computer model of a part in a three-dimensional discretized design space comprising three-dimensional geometrical elements; producing a signed distance field based on a geometry of the three-dimensional discretized computer model of the part as represented in the three-dimensional geometrical elements of the three-dimensional discretized design space; and generating at least one non-branching cooling channel in a portion of the three-dimensional discretized design space using at least one predefined pattern and the signed distance field.

The operations can include obtaining a specified distance value, which is a desired distance between the part and the at least one non-branching cooling channel to be generated; calculating a three-dimensional geometrical element size based at least in part on a thickness of the part; determining a narrow band value based on the three-dimensional geometrical element size and the specified distance value; and for each three-dimensional geometrical element of the discretized design space having an absolute value of the signed distance field for the geometrical element which is greater than the narrow band value, assigning to the signed distance field for the three-dimensional geometrical element a value equal to the narrow band value multiplied by either a positive or negative sign of the signed distance field for the geometrical element prior to the assigning. The methods can include, for a narrow band value that exceeds a narrow band threshold, determining the narrow band value to be equal to the narrow band threshold, and recalculating the three-dimensional geometrical element size using the specified distance value and the narrow band threshold.

The operations can include obtaining a three-dimensional discretized computer model of a mold for the part, the three-dimensional discretized model comprising a mold core and a mold cavity, wherein the portion of the three-dimensional discretized design space corresponds to the mold core or the mold cavity; and obtaining a parting plane of the mold in the three-dimensional discretized design space, wherein the parting plane lies on an X-Y plane of the three-dimensional discretized design space. Obtaining the parting plane can include traversing the three-dimensional discretized design space in a Z direction starting from an outermost Z position of the three-dimensional discretized computer model of the mold; calculating, at each Z position, a cross-sectional area projected by the part on the X-Y plane; and locating the parting plane at a Z position where the calculated cross-sectional area is maximal.

Generating the at least one non-branching cooling channel in the portion of the discretized design space using the at least one predefined pattern and the signed distance field can include determining a transformed specified distance value based on the specified distance value and the three-dimensional geometrical element size; identifying a number of non-branching cooling channels to be generated in the portion of the design space; selecting an orientation for cooling lines having the predefined pattern; projecting the cooling lines according to the selected orientation on an outermost surface layer of the portion of the three-dimensional discretized design space; searching, for each three-dimensional geometrical element of the projected cooling lines from the surface layer and in a direction towards the part to find a three-dimensional geometrical element of the design space with a value of the signed distance field substantially equal to the transformed specified distance value from the part, and marking each found three-dimensional geometrical element as a cooling channel element of the non-branching cooling channels, which include the at least one non-branching cooling channel; and selecting cooling channel elements linked to only a single other cooling channel element to be projected out of the design space as inlet or outlet elements. The non-branching cooling channels can be defined by each respective set of the cooling channel elements between an inlet element and an outlet element.

Generating the at least one non-branching cooling channel in the portion of the design space using the at least one predefined pattern and the signed distance field can include determining a transformed specified distance value based on the specified distance value and the three-dimensional geometrical element size; identifying a number of non-branching cooling channels to be generated in the portion of the design space; selecting an orientation for cooling lines having the predefined pattern; projecting the cooling lines according to the selected orientation on an outermost surface layer of the portion of the three-dimensional discretized design space; searching, for each three-dimensional geometrical element of the projected cooling lines from the surface layer and in a direction towards the part to find a three-dimensional geometrical element of the design space with a value of the signed distance field substantially equal to the transformed specified distance value from the part, and marking each found three-dimensional geometrical element as a cooling channel element of the non-branching cooling channels, which include the at least one non-branching cooling channel; joining cooling channel elements to form a single non-branching cooling channel; and selecting cooling channel elements linked to only a single other cooling channel element to be projected out of the design space as inlet or outlet elements.

The three-dimensional discretized computer model of the mold can include a three-dimensional discretized computer model of one or more ejector pins. The signed distance field can be produced based on the geometry of the three-dimensional discretized computer model of the part and on the geometry of the three-dimensional discretized computer model of the one or more ejector pins.

The operations can include obtaining a discretized surface computer model of the part, the discretized surface computer model comprising surface geometrical elements; calculating the three-dimensional geometrical element size to be equal to the greater of i) an average thickness of the part, and ii) an average length of the surface geometrical elements; and generating the three-dimensional discretized computer model of the part in the three-dimensional discretized design space using the calculated three-dimensional geometrical element size and the discretized surface computer model of the part.

One or more aspects of the subject matter described in this specification can be embodied in one or more methods (and also one or more non-transitory computer-readable mediums tangibly encoding a computer program operable to cause a data processing apparatus to perform operations) that include obtaining a three-dimensional discretized computer model of a part in a three-dimensional discretized design space comprising three-dimensional geometrical elements; obtaining an inlet position of an inlet and an outlet position of an outlet for a non-branching cooling channel in a portion of the three-dimensional discretized design space; producing a signed distance field based on a geometry of the three-dimensional discretized computer model of the part as represented in the three-dimensional geometrical elements of the three-dimensional discretized design space; and generating the non-branching cooling channel in the portion of the three-dimensional discretized design space using a path search algorithm, the inlet position, the outlet position, and the signed distance field, wherein the non-branching cooling channel connects the inlet and the outlet.

One or more aspects of the subject matter described in this specification can also be embodied in one or more systems including one or more processors; and a computer-readable medium storing instructions that cause the one or more processors to perform operations including obtaining a three-dimensional discretized computer model of a part in a three-dimensional discretized design space comprising three-dimensional geometrical elements; obtaining an inlet position of an inlet and an outlet position of an outlet for a non-branching cooling channel in a portion of the three-dimensional discretized design space; producing a signed distance field based on a geometry of the three-dimensional discretized computer model of the part as represented in the three-dimensional geometrical elements of the three-dimensional discretized design space; and generating the non-branching cooling channel in the portion of the three-dimensional discretized design space using a path search algorithm, the inlet position, the outlet position, and the signed distance field, wherein the non-branching cooling channel connects the inlet and the outlet.

Generating the non-branching channel can include producing a block map based at least in part on the signed distance field, wherein the block map comprises, for each three-dimensional geometrical element in the three-dimensional discretized design space, a value indicating whether the three-dimensional geometrical element is blocked.

The block map can indicate as blocked one or more of i) three-dimensional geometrical elements with a value of the signed distance field lower than the specified distance value from the part, ii) three-dimensional geometrical elements representing a parting plane or an ejector pin, or iii) three-dimensional geometrical elements representing pre-existing cooling channels, and three-dimensional geometrical elements within a distance from the pre-existing cooling channel smaller than an inter-channel distance value.

Connecting the inlet and the outlet using the path search algorithm, the inlet position, the outlet position, and the signed distance field can include using the path search algorithm and the block map to generate a shortest path between the inlet position and the outlet position that does not traverse any of the three-dimensional geometrical elements indicated as blocked.

Connecting the inlet and the outlet using the path search algorithm, the inlet position, the outlet position, and the signed distance field can include connecting the inlet and the outlet using the path search algorithm and the block map to generate a path between the inlet position and the outlet position that circumvents the part and that does not traverse any of the three-dimensional geometrical elements indicated as blocked. Connecting the inlet and the outlet using a path that circumvents the part can further include indicating as blocked in the block map all the three-dimensional geometrical elements of the three-dimensional discretized design space that are located at a Z position that is farther than a predefined threshold from any of the inlet Z position and the outlet Z position; and generating a virtual obstacle between the inlet and the outlet using the block map. The operations can include generating at least one non-branching channel in a first portion of the three-dimensional discretized design space corresponding to a mold cavity; and generating, at least one non-branching channel in a second portion of the three-dimensional discretized design space corresponding to a mold core.

Particular implementations of the subject matter described in this disclosure can be implemented so as to realize one or more of the following advantages. Cooling channel layouts that provide a good coverage for a part can be automatically generated. Prescribed distances with respect to the part or other elements of the mold, such as ejector pins and/or parting planes, can be automatically taken into account. Optimized cooling channels positions can be obtained. Weighted temperature metrics that allow different channel layouts to be compared numerically with respect to prescribed design objectives can be used. The weights can be adjusted to achieve a balance between, for example, a part quality objective and a cycle time objective or to emphasize one or the other.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a system usable to generate and/or reposition cooling channels in a mold for injection molding.

FIG. 2 is a flowchart of an example of a process to optimize cooling channel positions.

FIG. 3 shows an example of a three-dimensional computer model of a conformal mold including cooling channels.

FIG. 4 shows an example of a computer model of a part and a cooling channel.

FIG. 5 is a flowchart of an example of a process to move cooling channel positions.

FIG. 6 is a flowchart of an example of corrections methods that can be applied to cooling channel elements.

FIG. 7 is a flowchart of an example of a nodal proximity method that can be applied to cooling channel elements.

FIG. 8 is a flowchart of an example of corrections methods that can be applied to cooling channel elements.

FIGS. 9A, 9B, and 9C show an example of an initial cooling channels layout, a corresponding optimized cooling channel layout, and a corresponding corrected optimized cooling channel layouts.

FIGS. 10A and 10B respectively show an example of an initial cooling channel layout according to some implementations and a corresponding optimized cooling channel layout. FIGS. 10C and 10D respectively show an example of an initial cooling channel layout according to some implementations and a corresponding optimized cooling channels layout.

FIG. 11 is a flowchart of an example of a process that can be used to generate a layout for cooling channels in the mold based on a predetermined pattern.

FIG. 12A shows a sectional view of an example of a three-dimensional computer model of a part and cooling channels projected on the outermost layer of a three-dimensional design space.

FIG. 12B shows a sectional view of an example of a three-dimensional computer model of a part and cooling channels generated according to some aspects of this disclosure.

FIG. 13 is a flowchart of an example of a process that can be used to determine a narrow band value for a part.

FIG. 14 is a flowchart of an example of a process that can be used to generate a cooling channel layout according to some aspects of this disclosure.

FIGS. 15A and 16A show examples of patterns used to generate a cooling channel layout according to some aspects of this disclosure.

FIGS. 15B and 16B show examples of cooling channels layouts generated according to some aspects of this disclosure.

FIG. 17 is a flowchart of an example of a process that can be used to generate a layout for cooling channels in the mold using a path search algorithm.

FIG. 18 is a flowchart of an example of a process that can be used to generate a cooling channel layout according to some aspects of this disclosure.

FIG. 19 is a flowchart of an example of a process that can be used to generate a cooling channel layout according to some aspects of this disclosure.

FIGS. 20 and 21 show examples of cooling channels layouts generated according to some aspects of this disclosure.

FIG. 22 is a flowchart of an example of a process that can be used to generate a parting plane of a mold.

FIG. 23 is a block diagram illustrating an example of a processing apparatus that can be used with aspects of this disclosure.

Like reference numbers and designations in the various drawings indicate like elements.

### DETAILED DESCRIPTION

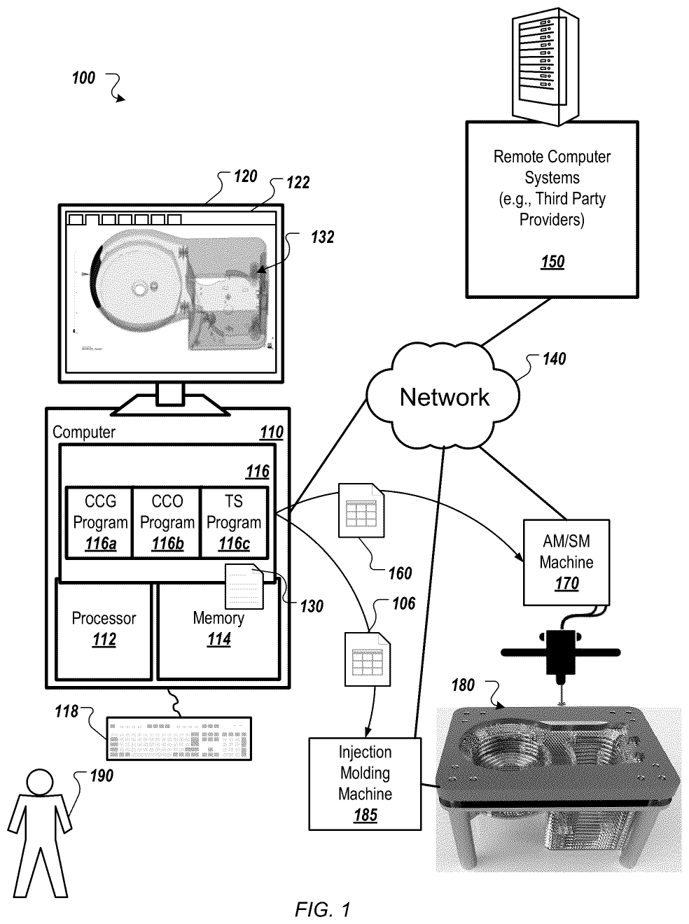

FIG. 1 shows an example of a system usable to generate and/or reposition one or more cooling channels in a mold for injection molding. The “injection molding” as used in this application includes producing parts by injecting molten material into a mold, as well as overmolding, compression molding, injection-compression molding, and insert molding manufacturing processes.

A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs 116 that run on the processor 112.

Such programs can run locally on computer 110, remotely on a computer of one or more remote computer systems 150 (e.g., one or more third party providers' one or more server systems accessible by the computer 110 via the network 140) or both locally and remotely. The programs 116 can present a user interface (UI) 122 on a display device 120 of the computer 110, which can be operated using one or more input devices 118 of the computer 110 (e.g., keyboard and mouse). Note that while shown as separate devices in FIG. 1, the display device 120 and/or input devices 118 can also be integrated with each other and/or with the computer 110, such as in a tablet computer.

A user 190 can interact with the one or more programs 116 to create and/or load a model of a part to be manufactured by injection molding. In some examples, the user 190 can interact with the one or more programs 116 to create and/or load a model of a mold for the part to be manufactured. The user 190 can interact with the one or more programs 116 to create and/or load initial layouts for one or more cooling channels that will be built inside the mold. For example, the models can be loaded from non-volatile memory or storage of the computer 110, can be received from another computer program, or can be designed in the programs 116. This can be done using known graphical user interface tools. The models can be defined in the computer using various known modeling formats, such as using solid models (e.g., voxels) or surface models (e.g., B-Rep (Boundary Representation), surface meshes, etc.). In some implementations, the models can include computer generated models of the mold in three dimensions that are stored in the computer 110 as two-dimensional (2D) based model representations of the part, e.g., a shell model.

In some implementations, the one or more programs 116 include a cooling channels generation (CCG) program 116a, a cooling channels optimization (CCO) program 116b, and/or a molding thermal simulation program (TS) 116c, e.g., Moldflow® software, available from Autodesk, Inc., of San Francisco, California, or Sigmasoft® software, available from SIGMA Plastic Services, Inc., of Schaumburg, Illinois, or Moldex3D® software, available from Coretech Systems Co., Ltd., of Taiwan.

The CCG program 116a, the CCO program 116b and the molding thermal simulation program 116c can be standalone software applications, or be integrated with each other and/or with another software application, such as a computer aided design (CAD) or computer aided engineering (CAE) program 116. The user 190 or a program component of the system 100 can operate the CCG program 116a to select or generate an initial layout for one or more cooling channels.

In some implementations, the CCG program 116a can be used to generate an initial layout for the one or more cooling channels. In some implementations, the CCO program 116b can optimize the initial layout making use of the TS program 116c to determine optimized cooling channels positions that optimize a metric that takes into account an average temperature of a surface of the mold in contact with the part and temperature inhomogenities across a mold surface in contact with the part.

For example, as shown in FIG. 1, a representation 132 of a model of a mold for a part of a blender (which is but one example of many possible parts) is displayed in the UI 122. Using the CCG program 116a, cooling channels can be added to the model of the mold. Using the CCO program 116b with the TS program 116c, the cooling channels positions within the 3D model of the mold can be modified such that a metric is optimized. In some implementations, the metric is a weighted metric. For example, the metric can be a weighted sum of two or more metrics, each of them reflecting one or more optimization objectives.

For example, an optimization objective can be minimizing injection molding cycle time. Cycle time can be reduced by reducing the mold average temperature, which in turn reduces the cooling time. Another objective can be maximizing part quality. In general, a higher mold temperature results in a glossy finish on the surface of the part. A higher mold temperature also leads to a lower cooling rate, resulting in more stress relief. This reduces the amount of residual stress and hence the warpage in the part. Part quality can also be affected by temperate differences across the cavity surface of the mold. By reducing temperature differences of the mold surfaces in contact with the part, warpage can be reduced.

Part quality and cycle time objectives can be balanced by adjusting the weights of the metrics that make up the weighted metric. For example, the weighted metric can take into account an average temperature of a surface of the mold in contact with the part with a first predefined weight, and temperature inhomogenities across a mold surface in contact with the part with a second predefined weight. In some implementations, the weighted metric can also directly take into account a volumetric shrinkage variation for the part with a third predefined weight. The cooling channels can be moved to obtain an optimum cooling channel layout that minimizes the weighted metric.

The model of the cooling mold can be a model of the cooling mold that was previously designed for this injection molding process, such as the model 132. The model of the cooling mold can be stored as a document 130 and/or used to generate another representation of the model (e.g., a .STL file for additive manufacturing). Note that an electronic document (which for brevity will simply be referred to as a document) can be a file, but does not necessarily correspond to a file. A document may be stored in a portion of a file that holds other documents, in a single file dedicated to the document in question, or in multiple coordinated files.

The cooling channels layout as generated by the CCG program can be presented on the display device 120 in the UI 122. In some implementations, the UI 122 can further display the optimized layout generated by the CCG program 116a. In some implementations, the part to be manufactured can also be represented on the display device with a resulting temperature distribution superimposed on the part (not shown). After reviewing the temperature distribution and the cooling channel design, the user 190 can determine whether the cooling channel design is acceptable. In some implementations, after the 3D model of the cooling mold is determined, the 3D model can be used to manufacture a cooling mold 180, e.g., by an additive manufacturing (AM) process using a manufacturing machine 170.

For example, the one or more programs 116 can create a digital representation of the 3D model 132 of the cooling mold, and provide a document 160 (of an appropriate format) to the manufacturing machine 170 to create the cooling mold 180. Document 160 can include controlling instructions to operate the machine to create the mold 180. The manufacturing machine 170 can employ one or more AM techniques, such as granular techniques (e.g., Selective Laser Sintering (SLS) and Direct Metal Laser Sintering (DMLS)), extrusion techniques (e.g., Fused Deposition Modelling (FDM)), one or more subtractive manufacturing (SM) techniques, or any other suitable computer aided manufacturing methods, including potentially a combination of AM and SM processes. In addition, the user 190 can save or transmit the 3D model of the new cooling mold for later use. For example, the CAD program 116 can store a document 130 that includes the 3D model of the cooling mold.

The user can use an injection molding machine 185 to manufacture the part using an injection molding process, including using a cooling mold 180 manufactured using the model 132 of the cooling mold. The injection molding machine 185 can be directly connected to the computer 110, or can be connected via a network 140, as shown in FIG. 1.

The one or more programs 116 can create a digital representation of the 3D model of the part representing an amount of warpage predicted for the part manufactured using an injection molding process. The one or more programs 116 can generate appropriate parameters (e.g., an appropriate level of packing pressure) for the injection molding process and can provide a document 106 (of an appropriate format) to the injection molding machine 185, where the document 106 includes the appropriate parameters for the injection molding process to be performed using the injection molding machine 185.

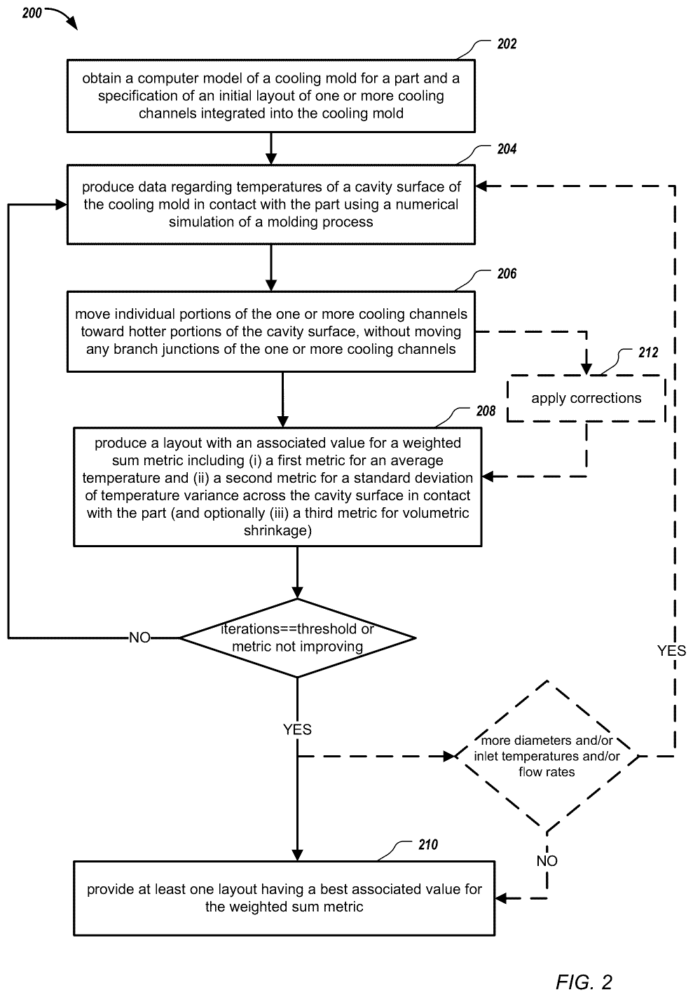

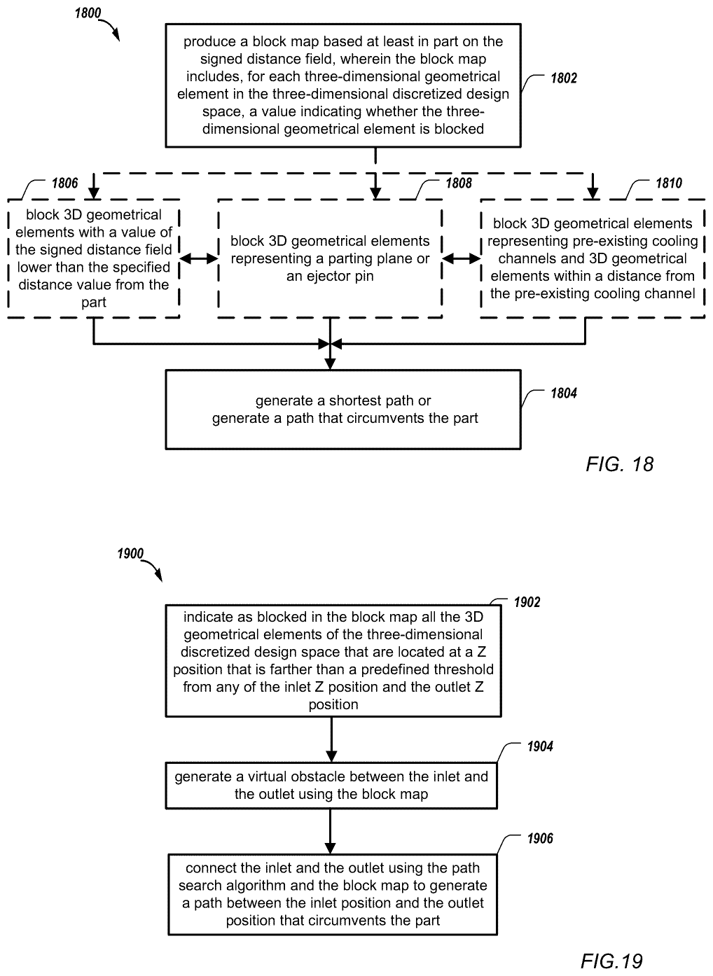

The injection molding machine 185 can employ one or more injection molding techniques to manufacture the part. In addition, the user 190 can save or transmit the appropriate parameters for the injection molding process for later use. For example, the computational simulation program 116 can store a document 130 that includes the appropriate parameters for the injection molding process. FIG. 2 shows an example of a process 200 (e.g., performed by CAD program 116 and/or CCO program 116b) to optimize cooling channel positions. For example, process 200 can be performed by the CCO program 116b using the TS program 116c. A three-dimensional computer model of a cooling mold for a part and a specification of an initial layout of one or more cooling channels integrated into the cooling mold are obtained 202. In some implementations, obtaining the initial layout of the one or more cooling channels in the cooling mold can include loading a previously designed cooling mold, producing a cooling mold design in response user input, generating the cooling mold channel layout using the systems and techniques described further below with respect to FIGS. 11 and/or FIG. 18, or a combination thereof. In some examples, the specification of the cooling channels can be included in the computer model of the mold. In other examples, the specification of the cooling channels can be obtained separately.

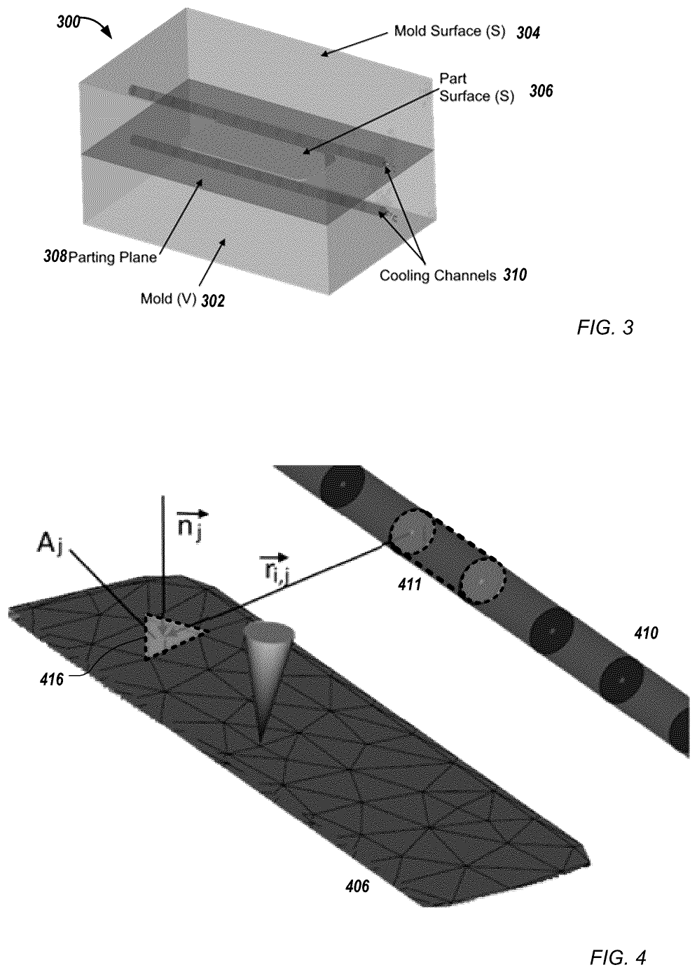

For example, FIG. 3 shows an example of a three-dimensional computer model 300. The model is represented by a three-dimensional region 302 which is bounded externally by a closed surface 304. The model 300 also includes a representation of cooling channels 310. The part surface 306 of a part to be manufactured with the mold is also represented in the cavity of the mold. Parting plane 308 defines the contact surface between the two halves of the mold.

Referring again to FIG. 2, data regarding temperatures of a cavity surface of the cooling mold in contact with the part is produced 204 using a numerical simulation of a molding process. In some examples, data regarding heat flux between the part and the cooling mold can also be obtained using a numerical simulation. For example, a boundary element method (BEM), a finite element method (FEM), a method involving voxel meshing, and/or conjugate heat transfer techniques used in computational fluid dynamics (CFD) solvers can be used to simulate a molding process applied to the cooling mold using the one or more cooling channels integrated into the cooling mold.

Traditional injection molding design aims to maintain the mold at a constant temperature for the entire injection molding cycle. To achieve this, coolant is pumped through the mold cooling channels with constant set inlet temperatures. For most part designs, this mold cooling process can be simulated sufficiently accurately by a steady-state solution of the mold temperature. This means that an average temperature during the molding cycle is calculated for each location throughout the mold. It is assumed that during a single injection molding cycle, the temperatures of mold locations in contact with the part only deviate slightly from the steady state cycle averaged temperature at each location. The variations of the steady state cycle averaged temperatures across the cavity surface of the mold determine the final shape of the part and the warpage of the part.

Some simulation methods can combine a transient time-dependent temperature solution in the part with a steady state temperature solution in the mold. Boundary element methods (BEM) are compatible with midplane, dual domain or full 3D representations of the part and the mold. For example, the cycle average heat transfer equation can be used to solve thermal conduction in the mold. Using a BEM to solve the Laplace equation (the steady state heat transfer equation) has the advantage that a volumetric representation of the mold is not required. To obtain a full steady state 3D temperature representation inside the mold, the mold can be represented by its outer boundaries together with a surface mesh of the part and a representation of the cooling channels inside the mold.

The boundary conditions can include heat transfer from the molten material (e.g., a polymer) on the mold's cavity surface, the coolant on the mold's channel surface and the stationary air on the mold's external surface. A full 3D finite element analysis can be performed on the part geometry for each cycle to calculate heat flux. This can in turn be iterated with the boundary element solution in the mold till convergence is reached between the solutions of the part, mold and cooling circuit network solver in the model. A full one-dimensional semi implicit pressure-linked equation solver to solve the flow in the cooling channels, coupled to a thermal solution in the channels, can be used to generate the boundary condition relating to the cooling channels. The cooling channels can be represented by one dimensional beam elements with an associated diameter. An hydraulic diameter can be used to represent irregular, i.e., non-round channel section shapes. In some examples, the hydraulic diameter can be calculated as four times the cross-sectional area of the non-circular channel divided by the wetted perimeter of the channel. The algorithm can use this diameter as if the channel were of a round shape. As explained in more detail below, the positions of the cooling channels can be moved in the mold to minimize a weighted sum metric in such a way that the average temperature of the mold in contact with the part can be minimized in order to reduce the cycle time and to reduce the temperature differences of the mold in contact with the part such that part warpage can be reduced.

When using the BEM to perform cooling channel layout optimization, the internal representation of the mold does not have to be re-meshed after each optimization step as only the outer boundary is necessary. However, when using the BEM to optimize the cooling channel layout, the relationships between all the elements in the model need to be re-calculated as these depend upon their spatial positions within the mold. Nonetheless, the results from the previous optimization step can be used as initial conditions for the new analysis as these would not change by much between optimizations. Further, the connectivities between all the elements remain the same, only their positions change. As the connectivities do not have to be re-calculated and existing results are used as starting conditions, a substantial speed-up in the solution can be achieved.

Individual portions of the one or more cooling channels can be moved 206 toward hotter portions of the cavity surface, without moving any branch junctions of the one or more cooling channels and while keeping one or more diameters of the one or more cooling channels constant. The moving can include limiting a maximum allowed movement of the individual portions based on the one or more diameters. In some examples, the maximum allowed movement can be computed as the diameter times a constant. In some examples, the constant can be set to a value between one-fourth of the diameter and three times the diameter.

In some implementations, the initial layout of the cooling channels includes serial channels, i.e., non-branching channels, that is, channels that do not include any splits into two or more channels between an inlet and an outlet for the channel. In some implementations, the initial layout includes branching channels. However, the junctions of the channels are kept fixed during the moving. In some implementations, only cooling channel elements are moved. In this case, the original positions of associated equipment, such as hoses, baffles, and/or bubblers remains stationary during the moving. In some implementations, the position of the inlet and the outlet of the channels and/or the angle with which a channel enters the mold is also maintained. The length of the channel can be increased or decreased during the optimization.

In some implementations, the cooling channel diameter is also not altered during the optimization. This ensures that the original cooling flow regime, preferably turbulent flow, is maintained. Fully turbulent flow in a cooling channel is the most efficient way of removing heat.

The producing and the moving produces 208 a layout that has an associated value for a weighted sum metric. In some implementations, the weighted sum metric can include (i) a first metric for an average temperature of the cavity surface in contact with the part and (ii) a second metric that measures temperature inhomogeneity across the cavity surface in contact with the part. For example, the second metric can be a measure of the statistical dispersion of the temperature variance across the cavity surface in contact with the part, e.g., a standard deviation of temperature variance across the cavity surface in contact with the part. In some examples, the weighted sum metric can include (iii) a third metric for volumetric shrinkage variation for the part.

This process can be repeated multiple times to produce multiple different layouts for the one or more cooling channels. In some examples, a fixed number of iterations, equal to an iteration number threshold, can be performed. In some examples, the processes are iterated until one or more metrics no longer improve significantly. In some examples, an input cooling-channel layout for each subsequent repetition of the producing is an output cooling-channel layout from a prior repetition of the moving.

In some implementations, obtaining 202 the computer model can include identifying at least two different diameters for at least a single one of the cooling channels. For example, different diameters can be obtained from user input, defined in the specification of the initial layout, or predefined by the program 116 and/or CCO program 116b. The above-described processes 204, 206, 208 can be repeated using each respective different diameter, starting from the initial layout for each respective different diameter, to produce the multiple different layouts for the one or more cooling channels.

In some implementations, obtaining 202 can include identifying different inlet temperatures and/or flow rates. For example, different inlet temperatures and/or flow rates can be obtained from user input, defined in the specification of the initial layout, or predefined by the program 116 and/or CCO program 116b and/or TS program 116c. The above-described processes 204, 206, 208 can be repeated using respective combinations of inlet temperature and flow rate, starting from the initial layout for each respective combination, to produce the multiple different layouts for the one or more cooling channels.

During the optimization, one or more predetermined offset distances can be used as a constraint in the solver to ensure that the channels are not moved too close to the part or to the parting plane. A predetermined interchannel distance can also be used as a constraint to ensure that channels do not impinge upon each other.

The optimization routine moves the cooling channels closer to the areas of the part where the mold surface temperature in contact with the part is hotter than the average temperature of the mold in contact with the part. By cooling down the hotter areas of the mold in contact with the part to a temperature closer to the average temperature of the mold in contact with the part, the temperature variation across the part will be minimized. By having less of a temperature variation across the surface of the part, warpage of the part during the molding process to manufacture the part can be reduced or eliminated.

A full thermal analysis can be performed with the initial channel layout geometry that is provided to the solver. The aim of the solver is to move this initial channel layout geometry to optimum positions, thereby lowering the average temperature of the mold in contact with the part and minimizing the temperature variation across the surface of the mold in contact with the part. The temperatures of the mold cavity in contact with the part and the heat flux from the part into the mold obtained from this analysis can be used in the optimization routine.

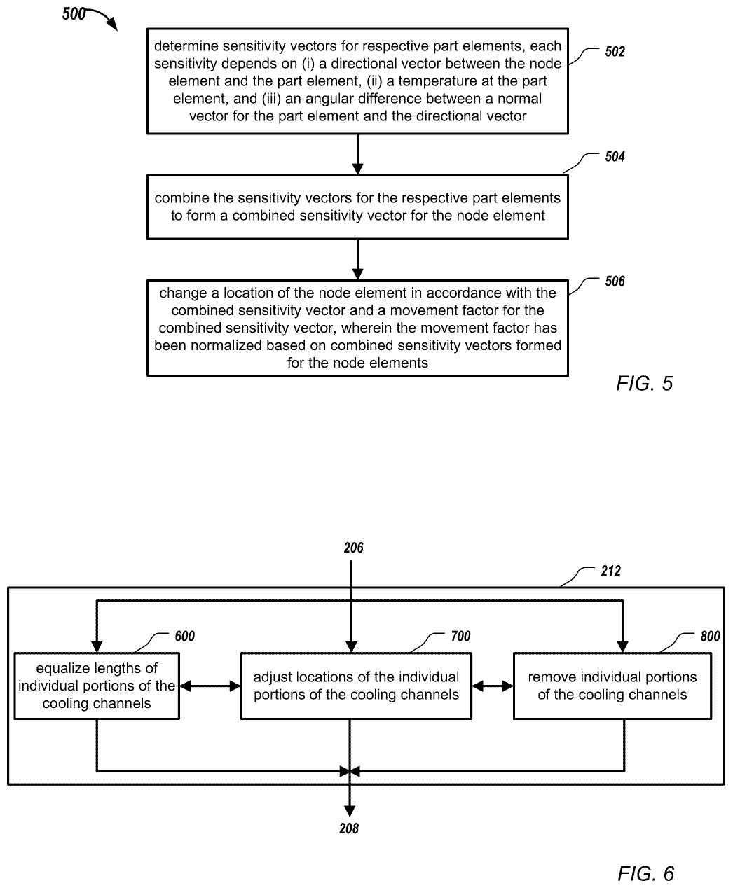

Referring to FIGS. 4 and 5, each non-branching cooling channel 410 can be represented by a series of one-dimensional beam elements of a specified length, such as beam element 411, defined by two nodes, each of the nodes representing the centroid of the section of the beam element, such as node i. A hydraulic diameter can be used to represent channel section shapes other than circular. In some examples, the section of the cooling channel to be generated can be round, square or trapezoidal, among others.

The one-dimensional format used for defining the cooling channel is beneficial for the algorithm as one can consider each beam element in turn and readily move its position in space without having to generate or modify any surface mesh elements or three-dimensional mesh elements for the cooling channel.

For every cooling channel element node i, e.g., a node connected to a one-dimensional cooling channel element, a sensitivity vector Si,. is determined 502 in process 500, e.g., performed by CAD program 116 and/or CCO program 116b, where j takes values between 1 and a number Np, of part elements influencing the position of channel node i.

$$\vec{{S}_{i , j}} = max ( \vec{{n}_{j}} \cdot \frac{\vec{{r}_{i , j}}}{\vert \vec{{r}_{i , j}} \vert} , 0. ) {T}_{j} \frac{\vec{{r}_{i , j}}}{\vert \vec{{r}_{i , j}} \vert} where i = 1 to N p$$

Vector rᵢ, is defined between the centroid of part element j (for example, triangular part element 416 with area Aⱼ) of a part surface 406, and the cooling channel node i (for example, node i, the centroid of the one-dimensional beam element 411 of cooling channel 410 node) under consideration. Vector nⱼ is defined as the unit normal vector on the part element j, taken from the centroid of the part element, pointing inward toward the center of the part. Tⱼ is the temperature of the mold in contact with the part element j.

With the above definition of the sensitivity term Si, only positive values of the vector dot product between the unit normal nⱼ of the part element j and the unit vector r_{i,j} between the cooling channel element i and the part element j are considered. This ensures that only part elements in a “direct line of sight” from the cooling channel element will influence the cooling channel element's position. Plastic is a very poor thermal conductor. Hence, mold elements that are in contact with an opposite surface of the part than that facing the cooling channel elements, are obscured by the part from the channel element's direct line of sight. Hence, these elements' influences on the position of the cooling channel under consideration can be excluded from the computation without loss of accuracy. In other words, cooling channel elements in a mold half are not influenced by mold elements of an opposite mold half for at least some types of molding materials.

Further, the dot product also ensures that cooling channel nodes with a vector rᵢⱼ that is perpendicular to the part element j under consideration are more influential. Also, the higher the temperature on the mold surface in contact with the part element, the more influential the part element is to the cooling channel element.

All the vector sensitivities from all the influential elements j influencing the cooling channel element i under consideration can be combined 504 into a single sensitivity for each cooling circuit element i, such as by using a weighting function or weight Wi,j defined as

$${W}_{i , j} = ( 1.0 - ( \frac{\vert \vec{{r}_{i , j}} \vert - {r}_{{min}_{i}}}{{r}_{{max}_{i} -} {r}_{{min}_{i}}} ) ) {A}_{j}$$

Aj is the area of the part element j. For each cooling channel element, the minimum rₘᵢₙᵢ and maximum rₘₐₓᵢ distances of the influential Np part elements in the part are defined as

$${r}_{{min}_{i}} = {min}_{j = 0 \leq N p} ( \vert \vec{{r}_{i , j}} \vert )$$

$${r}_{{max}_{i}} = {max}_{j = 0 \leq N p} ( \vert \vec{{r}_{i , j}} \vert )$$

The weight, ensures that mold elements in contact with the part that have a larger surface area, are more influential. It also assigns a higher influence to elements that are closer to the cooling channel element. The influencing element that is furthest away has no influence (Wi,j=0). Using this weighting function, Wi,j, all the influencing elements are reduced to a single channel element sensitivity vector Si.

$$\vec{{S}_{i}} = \frac{{Σ}_{j = 0}^{N p} ( {W}_{i , j} \vec{{S}_{i , j}} )}{{Σ}_{j = 0}^{N p} {W}_{i , j}}$$

Once a sensitivity vector Si has been assigned to every cooling channel node, maximum Sₘₐₓᵢ and minimum sensitivities Sₘᵢₙᵢ are calculated for each cooling channel node i, where Nc is the number of cooling channel nodes.

$${S}_{{min}_{i}} = {min}_{i = 0 \leq N c} ( \vert \vec{{S}_{i , j}} \vert )$$

$${S}_{{max}_{i}} = {max}_{i = 0 \leq N c} ( \vert \vec{{S}_{i , j}} \vert )$$

Once the maximum and the minimum sensitivities are calculated for all the cooling channel elements, a normalized cooling channel node movement factor M_{factori} can be defined as

$${M}_{f a {ctor}_{i}} = \frac{\vert \vec{{S}_{i , j}} \vert}{{S}_{{max}_{i}}}$$

The cooling channel node movement factor can be normalized. That is, the channel that is required to move the most will end up with a movement factor M_{factormax}=1.0 and the cooling channel that requires no movement will end up with the value M_{factormn}=0.0. When a cooling channel needs to be moved it will be moved in the direction of the sensitivity vector. Hence a movement vector Mvi can be defined as

$$\vec{{M}_{{v}_{i}}} = \frac{\vec{{S}_{i , j}}}{\vert \vec{{S}_{i , j}} \vert} {M}_{f a {ctor}_{i}}$$

When the cooling channels are moved 506, the maximum movement distance that a cooling channel node can be moved can be specified by the user or another program. Then, the cooling channel node that has a movement factor equal to 1.0, will be moved the specified maximum movement distance and all other nodes will be moved a fraction of this distance. In some examples, the maximum allowed movement can be computed as the diameter times a constant. In some examples, the constant can be set to a value between one-fourth of the diameter and three times the diameter. In some implementations, if the cross-section of the channel node is not circular, its associated hydraulic diameter can be used to determine the maximum allowed movement.

Small movements of the cooling channels can cause big differences to the cooling characteristics of the mold. Hence, it is convenient to avoid drastic movements of the cooling channels between successive iterations. The movements of the cooling channels also need to be controlled to prevent cooling channels from intersecting the part, from moving across parting planes, or moving into each other. For example, users can specify keep-out regions, such as ejector pins or inserts where no cooling is required. In some implementations, a universal factor can be chosen to keep the distances between the cooling channel elements and these molding components. The factor chosen can be equal to a single channel diameter and is used to optimize the minimum distance between components. The user can modify this factor by multiplying it by a number so as to obtain a universal factor equal to a multiple or a fraction of the single channel diameter. The universal factor can also be used in conjunction with the movement factor M_{factor} and movement vector M_{vector} when moving the channel elements. For example, the most a node will move during an optimization can be equal to the universal factor. For example, the most a node will move during an optimization can be equal to a single channel diameter, a fraction of a single channel diameter or equal to a single channel hydraulic diameter or a fraction of the hydraulic diameter if the cross-section of the channel is not circular.

As the goals of the cooling analysis are to minimize the injection molding cycle time, by reducing the cooling time and to minimize the temperature difference across the surface of the mold in contact with the part, two metrics are defined which attempt to reduce these two goals to two single numerical values.

The first metric can be a normalized average mold temperature in contact with the part. The average surface temperature of the mold in contact with the part is dictated by the molding material. Some materials like nylons or polycarbonates require a very high mold temperature, whereas polypropylenes or polystyrenes require much cooler mold temperatures. The coolant temperatures can be set accordingly to guarantee the overall mold temperatures. The first metric is defined as the average temperature at an iteration iter normalized using the initial average temperature, Tm=Taverageᵢₜₑᵣ/Taverageᵢₙᵢₜᵢₐₗ. In some implementations, the average temperature is an area-weighted average temperature.

As the average mold temperature in contact with the part decreases, this first metric (a fraction smaller than one) decreases, which means that the layout design has improved. If the metric goes up, it shows that subsequent design iterations are worse than the previous one.

In some examples, if there are vast improvements in this metric during the optimization, another analysis can be run on the final design to ensure that the final mold temperature once again meets the resin requirements. This analysis can be set up to raise the final mold temperature by shortening the cycle time.

To minimize the temperature difference across the surface of the mold in contact with the part, a temperature variance Tvariance will be used. The temperature variance for a mold element in contact with part element i is defined as Tvariance i=Ti−Tave. The area-weighted average temperature Tave of the mold in contact with the part element i is subtracted from the temperature of the mold in contact with the part element i, Ti. If an element is hotter than the area-weighted average temperature, the temperature variance for that element will be positive. If it is cooler, the temperature variance for that element will be negative. It will be equal to zero when the temperature variance for that element is at the average temperature.

The goal of the optimization is to get as many elements as possible to have a temperature variance close to 0.0. To achieve this, a measure of the statistical dispersion of the temperature variance is minimized. In some examples, the standard deviation of the temperature variance is minimized. The standard deviation measures an amount of dispersion of a set of values. A low standard deviation indicates that the values tend to be close to the mean of the set, while a high standard deviation indicates that the values are spread out over a wider range.

The minimization of the standard deviation of the temperature variance can be used to achieve the second objective of the plastic injection molding optimization. The standard deviation of the temperature variance is given by

$$σ = \sqrt[2]{\frac{{\int }_{S} {( {T}_{{variance}_{i}} )}^{2} ds}{{\int }_{S} ds}}$$

where S is the surface area of the part.

When trying to minimize the average temperature (first metric) of the mold in contact with the part, the circuit elements could get moved too close to the part. This could give rise to cold spots on the surface of the part. These cold spots would increase the temperature variance in these positions, which increases the standard deviation. In some implementations, to keep track of the standard deviation of the temperature variances between iterations, the standard deviation metric is defined by stdₘ=σᵢₜₑᵣₐₜᵢₒₙ/σᵢₙᵢₜᵢₐₗ.

If the standard deviation metric stdₘ decreases, it means that the overall temperature solution is tending to be closer to the average mold temperature in contact with the part. Using the standard deviation is a much more reliable method than using the temperature range, as the temperature range can be compromised by outlier results caused by external factors, such as poor modeling practices or bad mesh densities in critical areas.

Tm and stdm are normalized metrics. A weighted sum method with a weighting factor α is used to combine the two objectives of the optimization. The weighted metric is given by Metric=αTm+(1.0−α)stdm.

The weighting factor can be set by the user or a program other than the program computing the metric. A factor of α=0.5 can be chosen that gives both average mold temperature and temperature difference objectives equal weighting during optimization.

The aim of the cooling optimization analysis is to minimize this metric. During solver execution, the solver will update the positions of the cooling channels and do a full cooling analysis on the updated model. In some implementations, after an optimization run, the solver can print or store a table where the metric is written out for each layout. In some examples, the average temperature in contact with the mold, the standard deviation of the temperature variance, and their respective metrics can also be saved. The cooling channel layout can also be written out and saved to its own study file for further reference. The file can include the part and the mold models. A user can load any model into the user interface and re-analyze it afterward. The user or a program can detect the iteration where the Metric took the lowest value for the first time and select this model as an optimized model. In some implementations, an optimization algorithm can be used to stop the optimization when the metric no longer improves or does not improve beyond a specified threshold and output the values corresponding to the optimized layout.

In some examples, to maintain the integrity of the mesh and to preserve the accuracy of the thermal simulations, some additional corrections 212 can be applied to the cooling channel layout resulting from the moving 206. FIG. 6 is a flowchart showing examples of corrections that can be applied to the cooling channels, e.g., in each iteration, after the moving 206, before producing 208 the optimized layout for the iteration. For example, a nodal clustering correction 600, a nodal proximity correction 700 and/or a small elements removal correction 800 can be applied to the cooling channels.

In few scenarios are cooling analyses truly symmetric, due to the coolant heating up in the cooling channels as the channel traverses the mold. However, if the coolant inlets and outlets, plus the cooling channels, together with the part are symmetrical about a plane, then the cooling analysis can be considered symmetric. To guarantee that the optimization maintains symmetry, if the original mold is symmetric, the corrections 212 can be applied in such a way that symmetry is maintained.

In some implementations, the lengths of the individual portions of the cooling channels, i.e., cooling channel element lengths, can be equalized 600 so that cooling channel elements do not become too small or too large. Length-to-diameter ratios that are much higher or lower than a prescribed length-to-diameter ratio can affect the accuracy of the thermal simulation. For example, to preserve the accuracy of the simulations, cooling channel element lengths can be restored to values at around approximately 2.5 times their diameter or hydraulic diameter. Accordingly, in some examples, the solver can apply a nodal clustering correction to ensure 600 that the beam elements lengths do not become too small and/or too large.

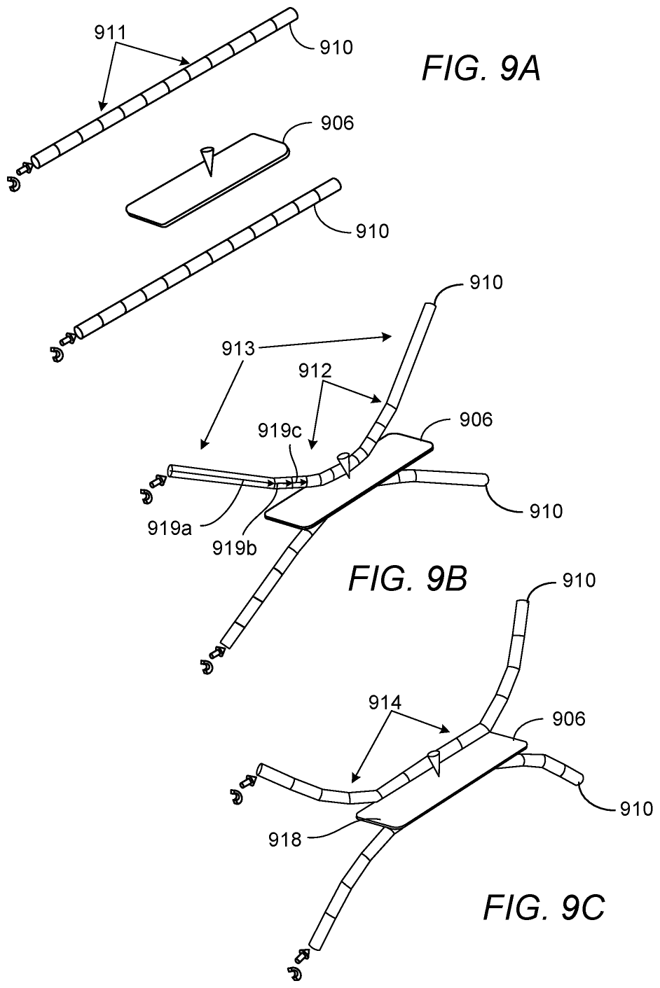

FIG. 9A shows an example of an initial cooling channels layout including two cooling channels 910, each of them located on a different half of a mold (not shown), surrounding a flat plate part 906. Initially, the nodes of the channels are evenly spaced throughout the length of the channel and all the elements 911, e.g., beam elements, are of the same length. If the part 906 has a defined region, e.g., a hot spot, in the mold that is much hotter than any other position in the mold, the moving 206 tends to move all the cooling channel nodes to this region where cooling is required. FIG. 9B shows the cooling layout resulting from the optimization without applying 212 any corrections. Cooling nodes are clustered in one region around the center of the plate where the hottest regions occur. Since the number of elements in each cooling channel is kept fixed during the thermal simulation 204 and the moving 206, the presence of a hot spot in the part 906 leads to a region with very small elements 912 while leaving the elements 913 close to the inlets and outlets very sparse and much longer than elements 912.

In some examples, to prevent the nodes 912 from clustering in the hot spot region close to the center of the part, a nodal clustering correction can be applied 600 to equalize the lengths of the elements. In some implementations, after each iteration, the angles of the cooling channels, moving from the inlets and outlets toward the center of the channel are preserved with the nodes moved along the channel to equalize 600 the lengths of the elements. Each cooling channel element can be described as a three-dimensional vector 919a, 919b, 919c pointing from an initial node of the channel element to an ending node of the channel element. Each node has two three-dimensional vectors corresponding to the two channel elements attached to it. The angle between these two vectors, i.e., between the two elements is preserved during the nodal clustering correction, while the lengths of the elements are changed so as to stop all the elements' lengths from getting very short near the hot spots and hence avoid clustering of the cooling channel nodes in the regions of the hot spots. As a result of correction 600, the elements are then all again of similar length and the basic shape of the optimized channel 910 is maintained.

When optimizing a cooling channel, it is convenient to preserve a predefined proximity distance of the cooling channels with respect to the part, other cooling channels, ejector pins, parting planes and/or keep-out regions of the mold, thus ensuring that the cooling channels do not get too close to each other, various portions of the mold, or the part. The proximity (or exclusion) distance that the cooling channel can encroach on other elements can be set by the user, by program 116, or a combination thereof. For example, a dimensionless proximity distance can be used. The dimensionless proximity distance can be equal to a number of channel diameters that the cooling channel needs to be away from the other components. The dimensionless proximity distance can be a non-integer number. In some examples, this correction is applied in such a way that symmetry is also maintained.

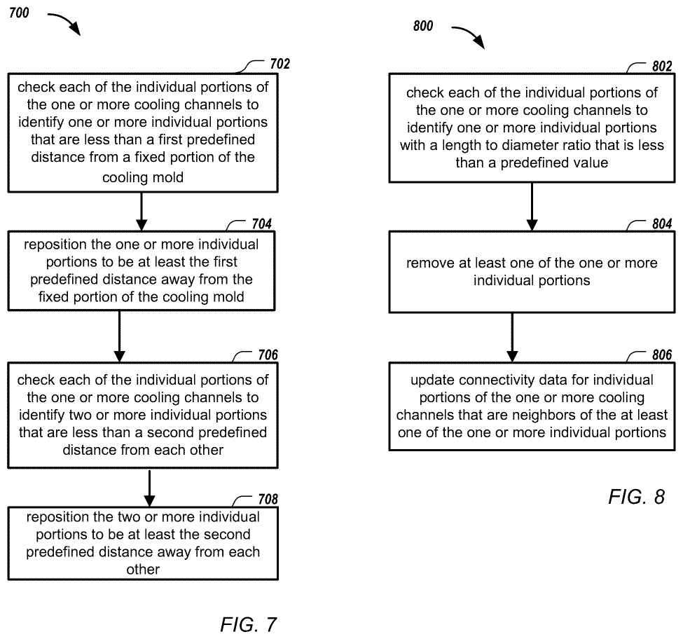

FIG. 7 is a flowchart of an example of a nodal proximity correction method 700. In some examples, the nodal proximity correction algorithm assumes that the initial channel layout input to process 200 respects all the proximity rules. After an iteration optimization is run, the solver can check 702 the distance of all the cooling channel element nodes and/or one-dimensional beam centroids from the closest part element. If a cooling channel node is too close to the surface of the part, i.e., closer than a first predefined distance, i.e., the proximity distance, the excess distance that it is too close by can be used to calculate how far the node needs to move back in the direction it came from to satisfy the proximity distance. The node is moved back 704 this excess distance. In some examples, this method can be applied with respect to all the fixed sections in the mold, such as parts, runner systems, ejector pins and parting planes.

In some examples, the proximity of cooling channels to each other is also checked 706. After an optimization iteration, the channels are examined to check their distances from each other. If a channel element is judged to be too close to another element, i.e., closer than a second predefined distance, the excess distance it is too close by is used to calculate the distance the channel node is required to move by 708 in the direction it came from to satisfy the second predefined distance requirement.

In some examples, the node is only flagged with half the distance it must move back by. To maintain symmetry, if required, it can be assumed that the other node that the flagged node is too close to, will be flagged with a similar distance by the nodal proximity correction algorithm 700.

Once all the nodes have been checked, the distances and directions that the nodes were flagged by, can be applied 708 to all the nodes at the same time. The routine 700 can then check the proximity rules again and a similar procedure can be applied till all the proximities are respected. The routine can be designed in such a way that, in the worst case, all the nodes will just revert to their original positions if proximity cannot be maintained. Hence, if the initial model respected the proximity constraints, the final model will also respect the proximity constraints.

FIG. 9C depicts the optimized channel layout of FIG. 9B after nodal clustering 600 and nodal proximity 700 corrections are applied. The cooling channel elements 914 are all of similar length. Further, the resulting layout respects a proximity distance 918 equal to a single diameter distance.

In some examples, the initial cooling channel layout can be specified 202 all around the outer regions of the part in the mold. These cooling channel element lengths can also respect a prescribed channel element length of, e.g., 2.5 times the cooling channel element diameter. If an initial cooling channel has both the channel inlet and outlet on the same side of the mold, the entire length of the cooling channel will shorten during optimization 206. If the cooling channel shortens, at least some of the channel elements can fall under the prescribed length of the element. Referring back to FIGS. 2 and 6, a correction can be applied 212, 800 such that some of these channel elements can be squeezed out of the model. The elements can be squeezed out in a way that symmetry is maintained.

FIG. 8 is a flowchart of an example of a small element removal correction method 800. In some examples, to guarantee symmetry, the routine 800 can march through and check 802 all the cooling channel elements in the mold and can identify 802 all the cooling channel elements that are too short, e.g., cooling channel elements with a length-to-diameter ratio that is less than a predefined value. For example, the predefined value can be approximately equal to 2.5. In some implementations, all the elements that are too short can be removed 804 and the connectivity of the neighboring channel elements can be updated 806 accordingly.

In some implementations, the elements identified as too short can be added into a series of lists to be removed 804. A list can include contiguous elements from the same channel that are too short. If, when the algorithm marches through a channel, an element is found that satisfies the length requirement, the current list is closed off. A new list can be started if another element within the same channel is found to be too short. Once all the elements that are too short have been collated in these lists, a “squeezing” routine can be applied to each list. In some examples, the middle element in each list can be squeezed out, i.e., removed 804.

In some examples, if the list includes an even number of elements, the two elements in the middle of the list can be combined into one element. In some examples, the node in the middle of the two elements will be eliminated together with the element that has the highest list identification number of the two. The connectivity of the neighboring elements will be updated to reflect this elimination.

In some examples, if the list includes an uneven number of elements, the element in the middle of the list is eliminated. The nodes on either end of the element can be moved to the center of the element and merged into a single node. In some examples, the element is eliminated but the neighboring element's nodes are moved to the center of the eliminated element to maintain symmetry. The connectivity of the neighboring elements is then updated.

In some examples, this routine can applied to all the lists of elements that are too short. Once an element is eliminated from a list, the list can be destroyed. Once all the lists are destroyed, the algorithm is repeated, making a series of new lists and eliminating elements, until all the elements left satisfy the minimum length requirement. Once no more lists can be built, the corrected layout for this iteration can be produced 208 and next iterations can continue.

Referring again to FIG. 2, at least one of the multiple different layouts for the one or more cooling channels having a best associate value for the weighted sum metric is provided 210. For example, a file including the at least one layout can be stored. The associated weighted sum metric can also be stored in the same or a different file. In some examples, the weighted sum metric for multiple different layouts can be displayed 210 to a user and/or stored for later access and use. In some examples, the first metric and the second metric are also provided 210, e.g., displayed to a user and/or stored for later access and use. In some examples, a user or another computer program can select the preferred layout in view of the metric(s). In some examples, the layout of cooling channels can be converted to a 3D model format compatible with the 3D model of the cooling mold and can be saved or export for manufacturing of the cooling mold with the integrated cooling channels of the layout therein. For example, the one-dimensional beam channel model can be converted to a mesh or BREP channel model for use by the CAD program 116 and/or the CCO program 116b.

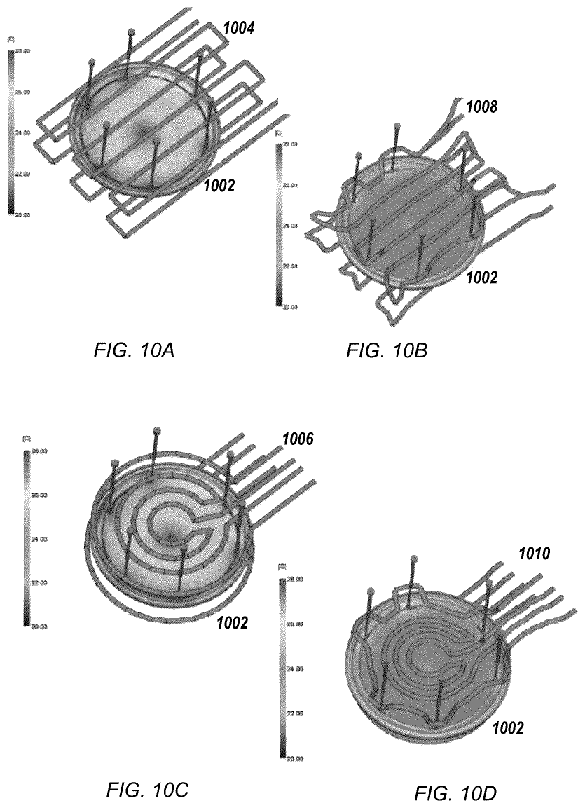

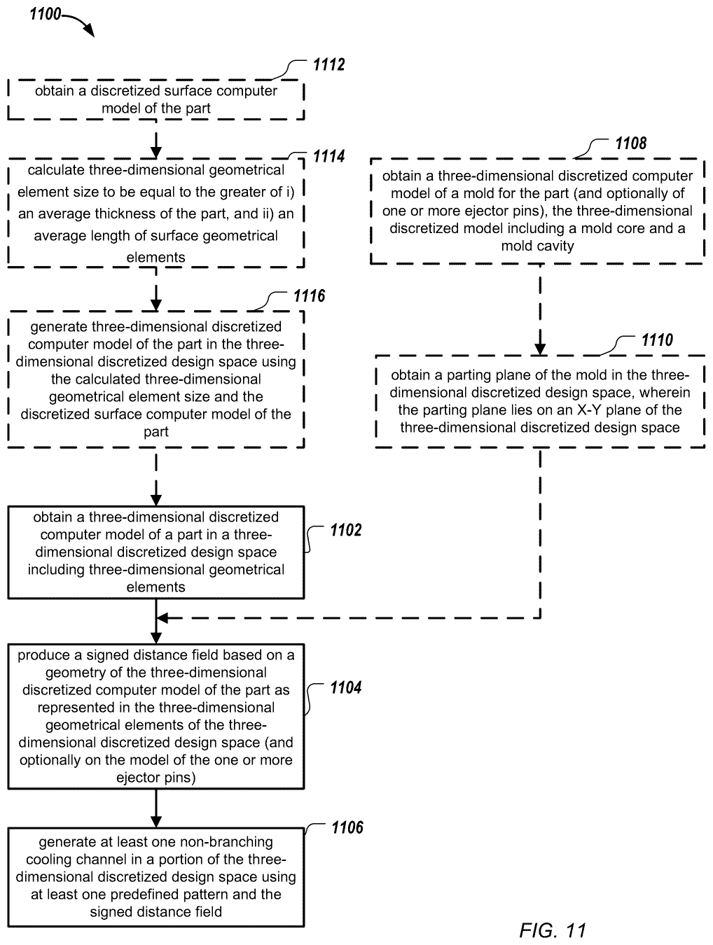

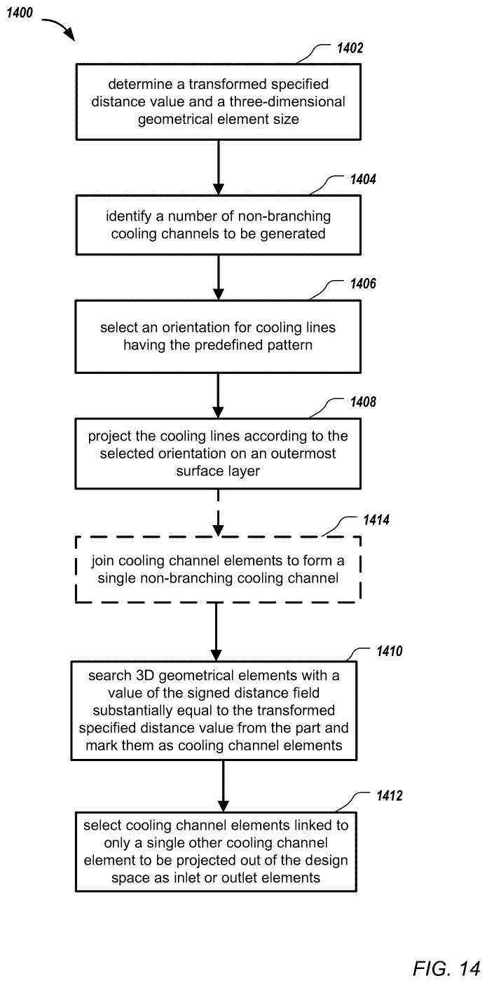

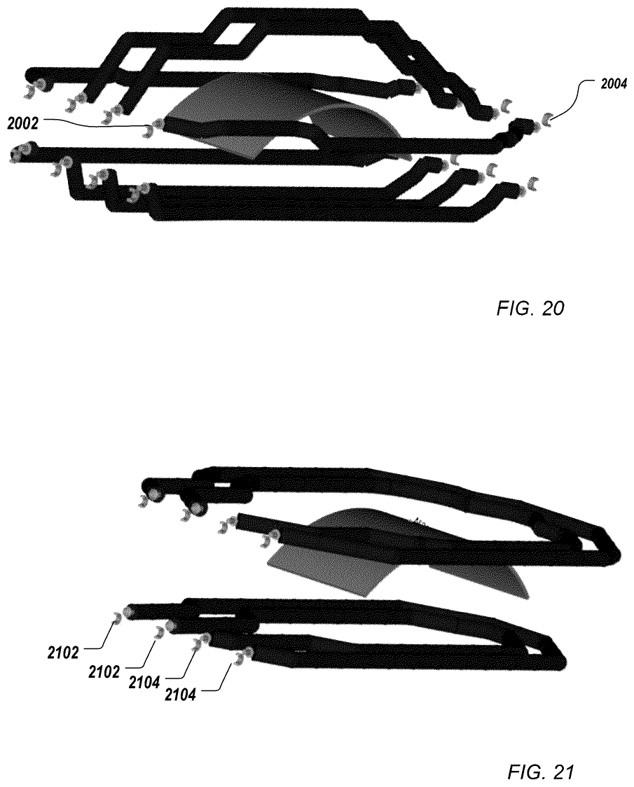

Referring to FIGS. 10A and 10C, two examples of initial cooling channel layouts 1004 and 1006 for part 1002 are shown. For example, cooling channel layout 1004 can be obtained as output of process 1100 of FIG. 11 or process 1400 of FIG. 14. Cooling channel layout 1006 can be obtained as output of process 1800 of FIG. 18 or process 2000 of FIG. 20. Cooling channel layouts 1004 and 1006 can be used as initial cooling channel layouts to be input to process 200. The same layout is used on each half of the mold in both cases. A different layout could be used on each half of the mold. FIG. 10B and FIG. 10D show, respectively, the final optimized layouts 1008 and 1010 obtained as output of process 200 for initial layouts 1004 and 1006. The temperature distribution on the part 1002 is shown for the initial layouts 1004, 1006 and for the optimized layouts 1008, 1010. In both cases, the optimized layouts 1008, 1010 provide a lower average temperature and a more homogenous temperature than the initial layouts 1004, 1006.

FIG. 11 is a flowchart of an example of a process 1100 (e.g., performed by CAD program 116 and/or CCG program 116a) that can be used to generate a layout for cooling channels in the mold based on a predetermined pattern. The generated layout provides a good coverage of the cooling channels across the part surface. In some examples, the generated layout can be used as an initial layout to be further refined using the method 200 of FIG. 2.

At 1102, a three-dimensional discretized computer model of a part in a three-dimensional discretized design space comprising three-dimensional geometrical elements is obtained. In some implementations, a tetrahedral, a hexahedral or a voxel mesh model of the part is obtained. In some implementations, the model is generated from a surface representation of the part. For example, a discretized surface computer model of the part, e.g., a triangular mesh model, or a BREP model of the part can be obtained 1112. If a BREP model is obtained, the BREP model can be meshed to obtain a mesh model. A three-dimensional geometrical element size, e.g., a voxel size, can be calculated 1114. In some implementations, the size of the voxels can be determined based on an average thickness of the part. For example, the voxel size can be chosen to ensure that there are a significant number of voxels filling the internal volume of the part. In some examples, the voxel size is chosen to be the greater of the average part thickness and the average part surface mesh element length.

A three-dimensional discretized model of the part in a three-dimensional discretized design space, such as a voxelized model of the part, can then be generated 1116 from the discretized surface computer model (or the BREP model) of the part using the calculated three-dimensional geometrical element size.

In some examples, a voxel mesh can be generated by filling a specified volumetric design space that encloses the entire domain of interest with voxels. The domain of interest includes the part. The voxels that intersect the part are labeled as part voxels to generate a voxelized model of the part. Voxels internal to the part are not labeled as part voxels.

In some examples, the domain of interest can also include a model of the mold, or a model of a mold cavity and/or a mold core. In some examples, a three-dimensional discretized computer model of the mold for the part can be obtained 1108. The three-dimensional discretized model can include a mold core and a mold cavity. In some implementations, a parting plane can be obtained 1110. Voxels that intersect the parting plane can be labeled as parting plane voxels. In some examples, the model of the mold can also include other injection molding components, such as ejector pins. In this case, the voxels that intersect ejector pins are also labeled.

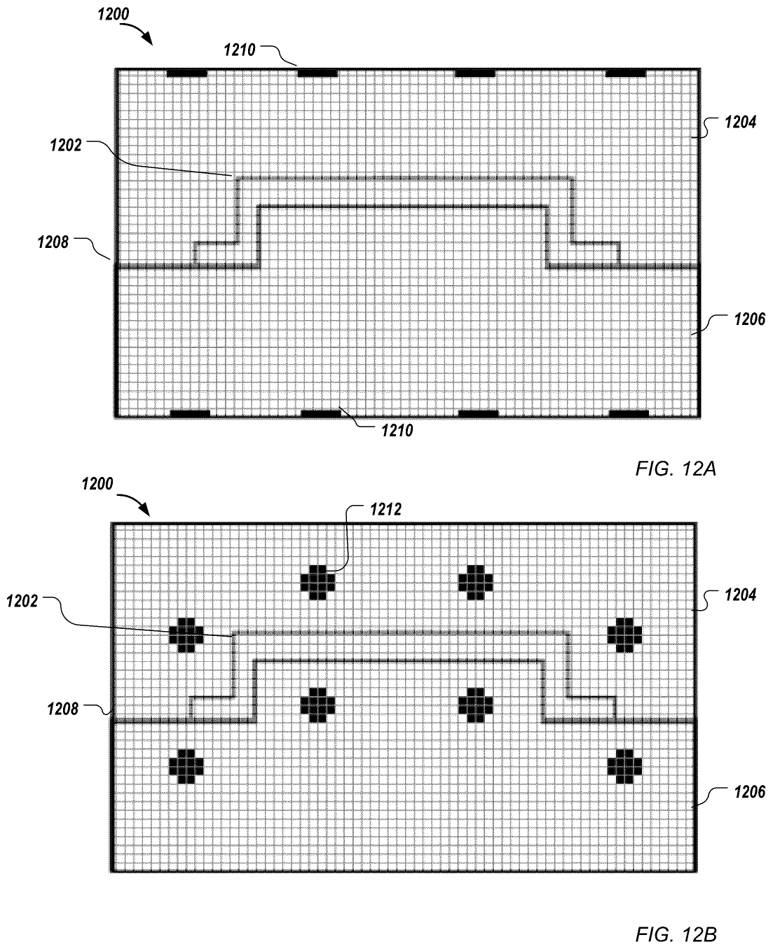

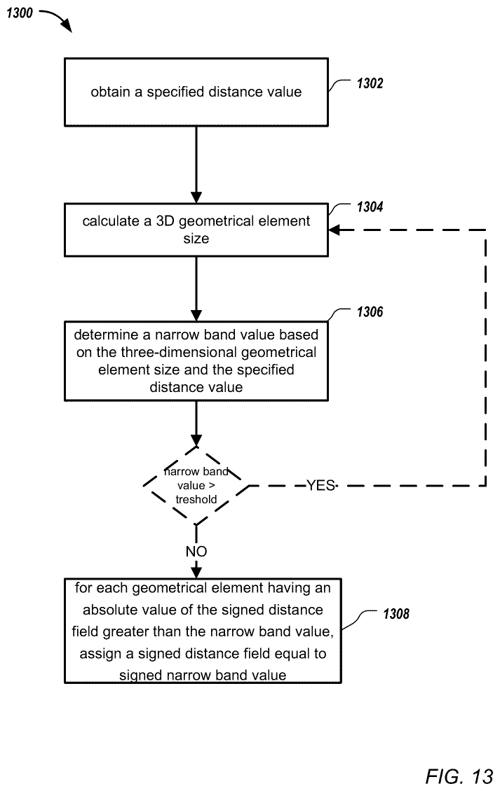

For example, FIGS. 12A and 12B show an example of a sectional view of a three-dimensional discretized design space 1200 including a model of a part 1202. The three-dimensional discretized design space 1200 is a three-dimensional voxel mesh. FIGS. 12A and 12B show a two-dimensional slice of the voxel space. The three-dimensional discretized design space also includes a region 1204 corresponding to a mold cavity and a region 1206 corresponding to a mold core as well as a parting plane 1208.

Referring again to FIG. 11, at 1104, a signed distance field based on a geometry of the three-dimensional discretized computer model of the part as represented in the three-dimensional geometrical elements of the three-dimensional discretized design space is produced. The signed distance field measures how close every three-dimensional element (e.g., a voxel) in the design space is to the part. If ejector pins are included in the model, the signed distance field can measure how close every voxel is to the part or an ejector pin.

Every voxel in the design domain is assigned a number representing the number of voxels from the closest voxel labeled as a part voxel or as an ejector pin voxel. To produce the signed distance field value for a voxel, an algorithm can traverse the design space in the six directions normal to the voxel cube faces until it finds a voxel labeled as a part or ejector pin. The least number of voxels to its closest part or ejector pin voxel is assigned to the voxel as its distance field. In some examples, voxels that fall outside the part or ejector pin are given a positive signed distance field number. Voxels that intersect the part or ejector pins are assigned a signed distance field equal to zero. Voxels that fall inside the volume of the part, i.e., are internal to the part, are also assigned a distance to the surface of the part. However, voxels internal to the part are assigned a negative distance value.

The size of the voxels can be determined based on an average thickness of the part. For example, the voxel size can be chosen to ensure that there are a significant number of voxels filling the internal volume of the part. In some examples, the voxel size is chosen to be the greater of the average part thickness and the average part surface mesh element length.

FIG. 13 is a flowchart of an example of a process 1300 for determining a narrow band around the part. At 1302, a specified distance value is obtained. In some examples, a user or a program can provide the specified distance value. The specified distance value corresponds to a minimum distance that the cooling channels are required to be away from the part. This predetermined value is used to define a narrow band around the part. In some examples, voxels that fall outside this narrow band are assigned the narrow band value in the signed distance field 1308. This enables speeding up the calculations (reducing the needed processing resources) and to saving of memory (reducing the needed memory resources).

In some examples, the narrow band can be defined by the voxel size and the specified distance from the part 1306 by the formula Narrow band=round[(User specified distance from part/Voxel size)+1]. This ensures that the narrow band is large enough for relatively accurate placement of the cooling channels in relation to the part. The cooling channels can be placed within a plus or minus voxel size from the specified distance from the part.

If the user specified distance from the part is very large in comparison to the three-dimensional element size, the resulting narrow band will be very large too. This can result in a very fine voxel mesh and can increase the solving time exponentially. In some examples, if the determined narrow band exceeds a threshold value, the narrow band can be capped to be equal to the threshold value (e.g., a value equal to 10). The voxel size can then be recalculated 1304 using the narrow band formula to calculate a voxel size corresponding to the threshold narrow band value and user specified distance from the part.

In some examples, a user or another program can also provide an interchannel distance value specifying a distance between channels to be respected when generating the channel layout.

The user specified distance from the part and the user specified interchannel distance can be converted into transformed distances expressed in terms of the number of voxels by dividing the actual distances by the voxel size. Voxels that have a signed distance field value substantially equal to the transformed user specified distances can be grouped together to form a cooling channel. The coordinates of the center of these grouped-together voxels can be joined to create a cooling channel that meets the specified distance from part. The cross-section of the cooling channels can be selected by the user. In some examples, the shape for the cooling channel to be generated can be round, square or trapezoidal, among others.

Referring again to FIG. 11, at 1106, at least one non-branching cooling channel is generated in a portion of the three-dimensional discretized design space using at least one predefined pattern and the signed distance field. In some examples, the portion of the three-dimensional discretized design space can correspond to a portion where a mold cavity would be positioned. In other examples, the portion can correspond to a portion where a mold core would be positioned. In some implementations, at least one non-branching cooling channel is generated in a portion corresponding to a mold cavity, and additionally, at least one non-branching cooling channel is generated in a portion corresponding to a mold core.

In an example, it is considered that the mold opens along a z-axis with the positive z axis pointing to the barrel of the injection molding machine. Hence the mold opens by moving the moving half of the mold in the negative z direction.

FIG. 14 is a flowchart of an example of a method 1400 to generate a cooling channels layout using a “direct pattern” method. At 1402, the transformed specified distance value and a three-dimensional geometrical element size are determined as explained above with reference to FIG. 13. In some examples, the number of cooling channels to be generated can be specified 1404 by a user or another program. In some implementations, the cooling channels will be evenly distributed across the projected area of the part on the x-y plane.

In some implementations, the direct pattern method allows the user to select a channel orientation 1406 for the cooling channels on the x-y plane. In some examples, the user can orient the channels parallel to either the X axis, the Y axis or to another direction (e.g., a user specified direction) in the x-y plane. In some examples, the orientation of the channels can be automatically chosen. For example, the channels can be oriented parallel to the larger of the X or Y dimension of the part.

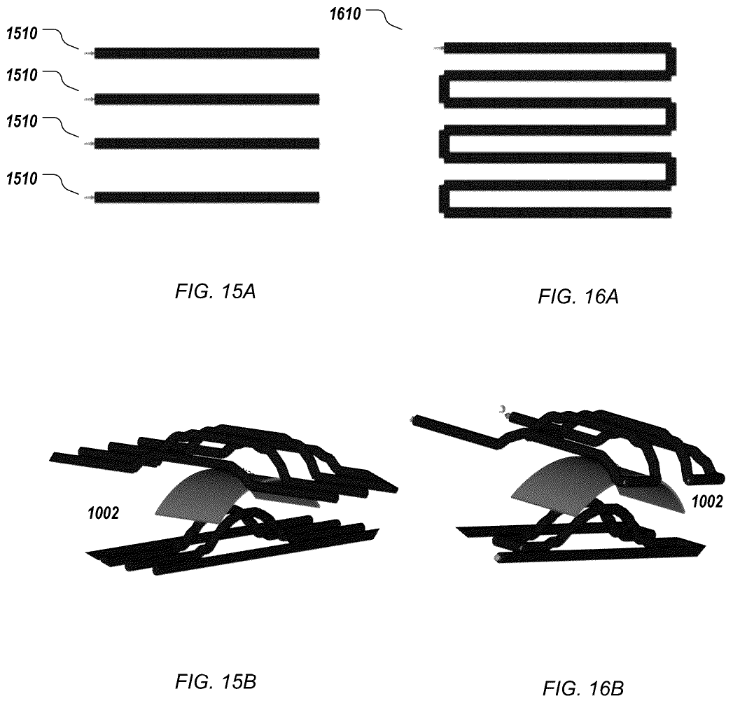

In some implementations, the direct pattern method projects 1408 the specified number of cooling channels with the chosen orientation on the 2D top surface layer of the voxel domain for the fixed half of the mold and/or on the bottom surface of the domain for the moving half. The voxels marked as channel voxels on the top or bottom surface represent the seeds of the cooling channel generation. FIG. 12A shows a sectional view of example cooling channels 1210 that have been projected on the outermost layers of the three-dimensional discretized design space. The pattern projected on the seed voxels in FIG. 12A corresponds to that shown in FIG. 15A with four evenly-spaced channels 1510.

In some implementations, from each seed voxel on the top surface, the algorithm traverses 1410 the design space in the negative z direction toward the part until a voxel with a transformed signed distance field equal to the transformed specified distance from the part is found. That voxel is then marked as a cooling channel voxel, and the search 1410 continues. In an implementation, once all the potential channel voxels have been found, cooling channel voxels that are not joined to two other cooling channel voxels can be selected and projected out 1412 to the walls of the mold in the channel orientation direction to define the inlet and outlet of the cooling channels.

If channels are also generated in the moving half of the mold, the same procedure is followed from each seed voxel 1210 on the bottom surface.

FIG. 12B shows an example of cooling channels 1212 obtained applying process 1400 departing from seed voxels 1210.

As shown in FIG. 12B for the cross-section of the channels, the underlying voxel mesh can produce channels with a voxelized or serrated appearance. In some examples, the voxel channels can be smoothed out in a longitudinal direction. For example, a straight section composed of multiple contiguous voxels along the channel can be squeezed into a single straight channel element with start and end locations corresponding to the start and end locations of the straight section, e.g., the multiple contiguous voxels can be lumped into one element, recording the start and end locations. The same procedure is repeated for all the voxels, generating a series of channel elements from an inlet to an outlet of the channel.

FIG. 15B shows an example channel layout resulting from applying a direct pattern method to the part 1002 using a pattern such as that shown in FIG. 15A.

In some implementations, a “zig zag” method can be used to generate the channel layout. The channels are generated in a similar manner as for the direct pattern method. However, the user specified number of channels are joined 1414 to create one single channel. In some implementations, these channels are joined once the search 1410 has ended and all the potential channel voxels have been found. In some implementations, these channels are joined 1414 at the time when the cooling channels are projected to the top or bottom 2D surfaces of the voxel mesh. An example of a projected pattern used in the zig zag method is shown in FIG. 16A. The inlet and outlet of the single channel 1610 are projected to the mold walls where the inlets and outlets can be specified. An example of a single cooling channel resulting from the zig zag method is shown in FIG. 16B.

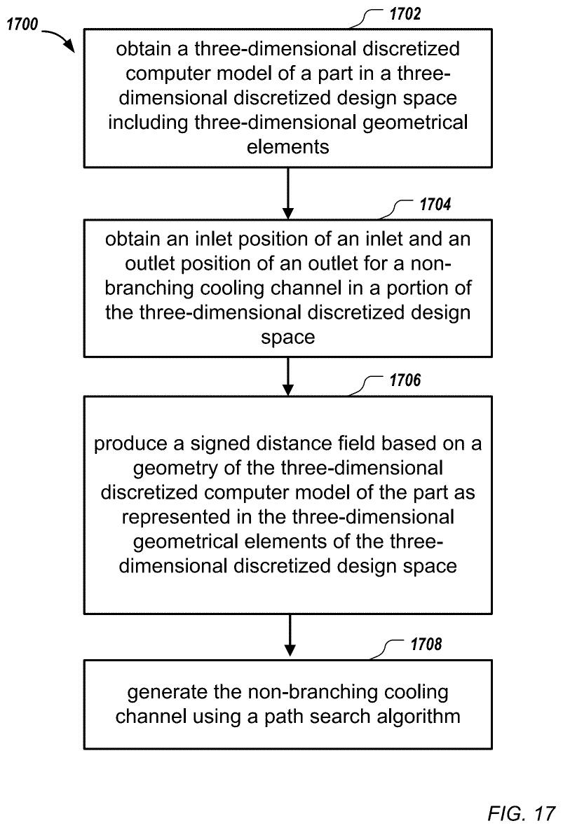

FIG. 17 is a flowchart of an example of a process 1700 (e.g., performed by CAD program 116 and/or CCG program 116a) that can be used to generate a layout for cooling channels in the mold based on a path search algorithm. The generated layout provides a good coverage of the cooling channels across the part surface. In some examples, the generated layout can be used as an initial layout to be further refined using the method 200 of FIG. 2.

Similar to the method of FIG. 11, at 1702, the method 1700 obtains a three-dimensional discretized computer model of a part in a three-dimensional discretized design space comprising three-dimensional geometrical elements.

At 1704, the method obtains an inlet position of an inlet and an outlet position of an outlet for a non-branching cooling channel in a portion of the three-dimensional discretized design space.

Similar to the method of FIG. 11, a specified distance from the part is also obtained from a user or another program.

Similar to the method of FIG. 11, at 1706, the method produces a signed distance field based on a geometry of the three-dimensional discretized computer model of the part as represented in the three-dimensional geometrical elements of the three-dimensional discretized design space.

At 1708, the method generates the non-branching cooling channel in the portion of the three-dimensional discretized design space using a path search algorithm, the inlet position, the outlet position, and the signed distance field, wherein the non-branching cooling channel connects the inlet and the outlet.

The goal of the path search method is to join the inlet node to the outlet node via a shortest path whilst avoiding the part, pre-existing cooling channels, parting planes, and ejector pins if present in the design space, while maintaining the specified distance from the part.

In some implementations, if multiple inlet and outlet nodes are specified in the model, the method can pair each inlet node to its closest outlet node and create a cooling channel between them. In some implementations, the algorithm can begin by first pairing the closest inlet outlet pair, and progressing to the next closest pair, until each inlet node is paired to its closest outlet node, thereby preserving symmetry in the resulting cooling channel layout.

The shortest path method can use any suitable path search algorithm to determine the shortest path between the inlet and outlet nodes. For example, a Dijkstra algorithm or a Breadth first search method can be used. In some implementations, the A* pathfinding algorithm is used. When using the A* algorithm to find the path from the user specified inlet node to outlet node, the algorithm will choose the shortest path between the two, unless any further restrictions are imposed. Restrictions can be represented in a block map parameter to be applied with the A* algorithm or other path search algorithm.

FIG. 18 is a flowchart of an example process 1800 that uses a path search algorithm to generate a shortest path between a specified inlet and an outlet node or a path that circumvents the part. At 1802, a block map can assign a Boolean value to each voxel in the design space indicating whether the voxel is blocked or not. If a voxel is blocked, it is treated as an obstacle by the A* function and the resulting path will avoid this blocked voxel. Using a block map, the path can be prevented from interfering with the part, pre-existing cooling channels, parting planes, and/or ejection pins, among others. The block map is then used with the path search algorithm to generate 1804 the shortest path or the path that circumvents the part.

In some examples, the space the channel can go through can also be limited by blocking a virtual layer of voxels, for instance to honor the specified distance between the part and the cooling channel, or to respect a minimum interchannel distance between adjacent cooling channels.

In an example, the block map can prevent 1806 the channel from going closer to the part than the specified distance from the part. In some implementations, the signed distance field can be used to that end. For example, all the voxels that have a signed distance field value lower than the user specified minimum distance from the part can be marked as blocked in the block map.

In some implementations, voxels representing parting planes and ejector pins can be blocked 1808 in the block map. In some implementations, multiple pairs of inlet and outlet nodes can be specified by the user. When generating a cooling channel for one pair of inlet and outlet nodes, the channel may block the path for any of the subsequent cooling channels that need to be generated. While generating these paths, the areas around the other cooling channel inlet and outlet pairs that are to be generated subsequently, may be temporarily blocked by adding voxels in the block map close to the inlet and outlet nodes ensuring that the channels cannot go too close to the other inlet outlet node pairs.

In some implementations, if multiple inlet and outlet pairs of nodes have been specified, the cooling channels can be generated sequentially. The cooling channels that are generated later during the sequence need to avoid the already generated cooling channels. The algorithm can loop through the voxels comprising the prior generated cooling channels and add 1810 them to the block map together with voxels near these voxels, honoring 1810 a specified interchannel distance between adjacent cooling channels.

In some examples, when there are multiple pairs of inlet and outlet nodes, a temporary block map copy is made of an existing block map before generating the shortest path. In the temporary block map, the other pairs of inlet and outlet nodes are blocked as described above. The A* function can then called with the temporary block map to generate 1804 the path from the inlet to the outlet node. After the channel is generated, the temporary block map can be discarded. Then, the original block map can be used, adding the newly generated channel to the block map.

In some examples, after all the channels between matching inlet and outlet nodes have been generated, the channels can be smoothed by removing the serrated nature of the underlying voxel meshes. Short cooling channel elements can be squeezed out as described above for the pattern method. Once the channel elements have been smoothened and squeezed, the cooling channels can be converted from voxels to xyz coordinates at the points where the cooling channel changes direction. In some examples, if the channel presents a straight section, the starting and end points of the section can be transformed to xyz coordinates to define the starting and end nodes of a channel element. If the direction of the channel changes, a new channel element is created.

FIG. 20 shows an example cooling channel layout resulting from a shortest path method according to some aspects of this disclosure. Each of the channels surrounds the part following a shortest path from an inlet 2002 to an outlet 2004.

In another example, a “circumferential path method” can be used. FIG. 19 is a flowchart of an example of a method 1900 to generate a cooling channel layout using a circumferential path method. The inlet and outlet nodes of the cooling channel can be specified in the same way as for the shortest path method. In some implementations, the circumferential method can be used when the inlet and outlet nodes of the cooling channels are on the same side of the mold. The program can create a cooling channel that begins with the inlet node and circumvents the part maintaining the minimum specified distance from the part and returning to the specified outlet node, avoiding parting planes and ejector pins. For example, this method can used for parts that are round when the user wants to maintain symmetry in the mold.

When multiple inlet and outlet nodes are specified on the same side of the part, the algorithm can pair an inlet node to its closest outlet node and generate a cooling channel between them. The algorithm can also begin by first pairing the closest inlet outlet pair first and then commencing to the next closest pair thereby preserving symmetry.

The circumferential method can also use the A* pathfinding function or any other path search algorithm to find the circumferential path between the inlet and outlet nodes. A block map can be used similarly to the one described for the shortest path method.

In some implementations, the channel placement in the z direction can be restricted to a small interval with respect to the original positions of the inlet and outlet nodes. The maximum and minimum z locations of the matching inlet and outlet pair of cooling nodes can be recorded. All the voxels in the mold that have the z dimension larger than the maximum limit by a specified number of voxels or less than the minimum limit by a specified number of voxels, are blocked 1902 in a temporary block map. This ensures that the cooling channel is predominantly generated in the same planes, with z locations of the cooling channel being between the z locations of the inlet and outlet nodes.

The circumferential method requires the path to circumvent the part in the mold instead of joining the inlet to the outlet node directly via the shortest path. To force the path to go around the part, a virtual obstacle can be created 1904 between the inlet and outlet nodes of the cooling channel. For each inlet and outlet node pair, the voxels on the part that are in proximity to the inlet outlet nodes in the z direction are projected on to a 2D slice in the voxel space. Once the 2D slice has been defined, the algorithm can find the midpoint between the user specified inlet and outlet cooling channel nodes. After the midpoint has been defined, the routine then looks for a point on the part cross section that is furthest away from the midpoint. Once this furthest point has been established, all the voxels on the path between the midpoint and the furthest point can be added to a temporary black map in the entire z direction allowed for this channel. This ensures that the path search algorithm cannot join the inlet to the outlet directly and has to circumvent the part to connect 1906 the inlet and the outlet.

FIG. 21 shows an example cooling channel layout resulting from a circumferential path method according to some aspects of this disclosure. Two circumferential channels with inlets 2102 and outlets 2104 are generated on each half of the mold.

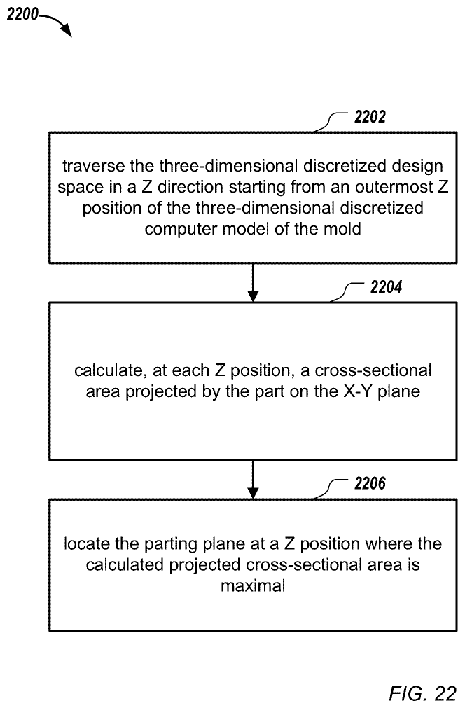

In some implementations, the cooling channel generation program can automatically generate the parting plane in the model if the parting plane has not been specified by the user or another program. FIG. 22 is a flowchart of an example of a process 2200 for generating the parting plane.

In some implementations, the automatic parting plane generation algorithm begins at the top of the mold and traverses 2202 the voxelized mold in the negative z direction. As it traverses each z-plane voxel layer, the projected cross-sectional area in the x-y plane that the part projects at that z position is calculated 2204 and recorded for each voxel layer in the z-plane. In some implementations, the first z-position where a maximal projected cross-sectional area is calculated and recorded, is taken to be the z position of the parting plane 2206. The design space below this plane can be considered to be the moving half of the mold and the design space above the plane can be considered to be the fixed half of the mold. In some examples, if this parting plane intersects the part, the upper surface of the part is considered to belong to the parting plane too as the part usually remains in the moving half during part ejection from the mold.

In some implementations, if the user specifies the inlet nodes or outlet nodes for the shortest path or circumferential methods on the automatically generated parting plane, the algorithm can ignore these specified nodes, propose inlet or outlet node positions close to the selected nodes but out of the parting plane, or flag them with a message indicating that the inlet and/or outlet nodes are positioned on the parting plane.

Referring again to FIG. 2, in some implementations, obtaining 202 a specification of an initial layout of one or more cooling channels integrated into the cooling mold can include generating at least one cooling channel on a first side of a three-dimensional design space using a predetermined pattern process 1100 or a path search algorithm 1800. In some implementations, obtaining 202 a specification of an initial layout of one or more cooling channels integrated into the cooling mold can further include generating at least one cooling channel on a second side of the three-dimensional design space using a predetermined pattern process 1100 or a path search algorithm 1800. The first side and the second side can each correspond to a half of the mold. In some examples, the first side can correspond to a mold cavity. In some examples, the second side can correspond to a mold core.

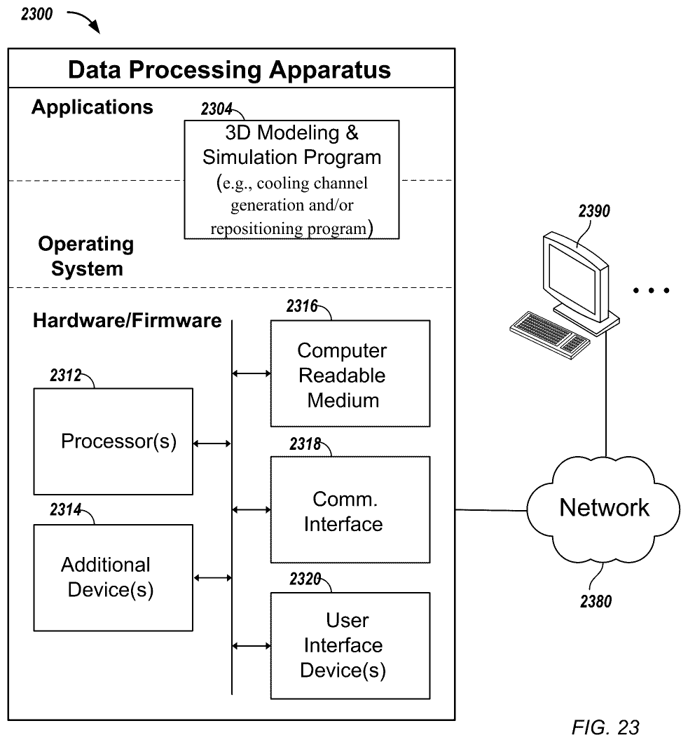

FIG. 23 is a schematic diagram of a data processing system including a data processing apparatus 2300, which can be programmed as a client or as a server. The data processing apparatus 2300 is connected with one or more computers 2390 through a network 2380. While only one computer is shown in FIG. 23 as the data processing apparatus 2300, multiple computers can be used. The data processing apparatus 2300 includes various software modules, which can be distributed between an application layer and an operating system. These can include executable and/or interpretable software programs or libraries, including tools and services of a 3D modeling and simulation program 2304, e.g., a cooling channel generation and/or repositioning program such as described above. The number of software modules used can vary from one implementation to another. Moreover, the software modules can be distributed on one or more data processing apparatus connected by one or more computer networks or other suitable communication networks.

The data processing apparatus 2300 also includes hardware or firmware devices including one or more processors 2312, one or more additional devices 2314, a computer readable medium 2316, a communication interface 2318, and one or more user interface devices 2320. Each processor 2312 is capable of processing instructions for execution within the data processing apparatus 2300. In some implementations, the processor 2312 is a single or multi-threaded processor. Each processor 2312 is capable of processing instructions stored on the computer readable medium 2316 or on a storage device such as one of the additional devices 2314. The data processing apparatus 2300 uses its communication interface 2318 to communicate with one or more computers 2390, for example, over a network 480. Examples of user interface devices 2320 include a display, a camera, a speaker, a microphone, a tactile feedback device, a keyboard, and a mouse. The data processing apparatus 2300 can store instructions that implement operations associated with the program(s) described above, for example, on the computer readable medium 2316 or one or more additional devices 2314, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, the actions recited in the claims can be performed in a different order and still achieve desirable results.

What is claimed is:

1. A method comprising:
obtaining a three-dimensional discretized computer model of a part in a three-dimensional discretized design space comprising three-dimensional geometrical elements;
producing a signed distance field based on a geometry of the three-dimensional discretized computer model of the part as represented in the three-dimensional geometrical elements of the three-dimensional discretized design space; and
generating at least one non-branching cooling channel in a portion of the three-dimensional discretized design space using at least one predefined pattern and the signed distance field.

2. The method of claim 1, comprising:
obtaining a specified distance value, which is a desired distance between the part and the at least one non-branching cooling channel to be generated;
calculating a three-dimensional geometrical element size based at least in part on a thickness of the part;
determining a narrow band value based on the three-dimensional geometrical element size and the specified distance value; and
for each three-dimensional geometrical element of the discretized design space having an absolute value of the signed distance field for the geometrical element which is greater than the narrow band value,
assigning to the signed distance field for the three-dimensional geometrical element a value equal to the narrow band value multiplied by either a positive or negative sign of the signed distance field for the geometrical element prior to the assigning.

3. The method of claim 2 comprising, for a narrow band value that exceeds a narrow band threshold,
determining the narrow band value to be equal to the narrow band threshold, and
recalculating the three-dimensional geometrical element size using the specified distance value and the narrow band threshold.

4. The method of any claim 1, further comprising:
obtaining a three-dimensional discretized computer model of a mold for the part, the three-dimensional discretized model comprising a mold core and a mold cavity, wherein the portion of the three-dimensional discretized design space corresponds to the mold core or the mold cavity; and
obtaining a parting plane of the mold in the three-dimensional discretized design space, wherein the parting plane lies on an X-Y plane of the three-dimensional discretized design space.

5. The method of claim 4, wherein obtaining the parting plane comprises:
traversing the three-dimensional discretized design space in a Z direction starting from an outermost Z position of the three-dimensional discretized computer model of the mold;
calculating, at each Z position, a cross-sectional area projected by the part on the X-Y plane; and
locating the parting plane at a Z position where the calculated cross-sectional area is maximal.

6. The method of claim 2, wherein generating the at least one non-branching cooling channel in the portion of the discretized design space using the at least one predefined pattern and the signed distance field comprises:
determining a transformed specified distance value based on the specified distance value and the three-dimensional geometrical element size;
identifying a number of non-branching cooling channels to be generated in the portion of the design space;
selecting an orientation for cooling lines having the predefined pattern;
projecting the cooling lines according to the selected orientation on an outermost surface layer of the portion of the three-dimensional discretized design space;
searching, for each three-dimensional geometrical element of the projected cooling lines from the surface layer and in a direction towards the part to find a three-dimensional geometrical element of the design space with a value of the signed distance field substantially equal to the transformed specified distance value from the part, and marking each found three-dimensional geometrical element as a cooling channel element of the non-branching cooling channels, which include the at least one non-branching cooling channel; and
selecting cooling channel elements linked to only a single other cooling channel element to be projected out of the design space as inlet or outlet elements;
wherein the non-branching cooling channels are defined by each respective set of the cooling channel elements between an inlet element and an outlet element.

7. The method of claim 2, wherein generating the at least one non-branching cooling channel in the portion of the design space using the at least one predefined pattern and the signed distance field comprises:
determining a transformed specified distance value based on the specified distance value and the three-dimensional geometrical element size;
identifying a number of non-branching cooling channels to be generated in the portion of the design space;
selecting an orientation for cooling lines having the predefined pattern;
projecting the cooling lines according to the selected orientation on an outermost surface layer of the portion of the three-dimensional discretized design space;
searching, for each three-dimensional geometrical element of the projected cooling lines from the surface layer and in a direction towards the part to find a three-dimensional geometrical element of the design space with a value of the signed distance field substantially equal to the transformed specified distance value from the part, and marking each found three-dimensional geometrical element as a cooling channel element of the non-branching cooling channels, which include the at least one non-branching cooling channel;
joining cooling channel elements to form a single non-branching cooling channel; and
selecting cooling channel elements linked to only a single other cooling channel element to be projected out of the design space as inlet or outlet elements.

8. The method of claim 4, wherein the three-dimensional discretized computer model of the mold comprises a three-dimensional discretized computer model of one or more ejector pins, and wherein the signed distance field is produced based on the geometry of the three-dimensional discretized computer model of the part and on the geometry of the three-dimensional discretized computer model of the one or more ejector pins.

9. The method of claim 2 comprising:
obtaining a discretized surface computer model of the part, the discretized surface computer model comprising surface geometrical elements;
calculating the three-dimensional geometrical element size to be equal to the greater of
i) an average thickness of the part, and
ii) an average length of the surface geometrical elements; and
generating the three-dimensional discretized computer model of the part in the three-dimensional discretized design space using the calculated three-dimensional geometrical element size and the discretized surface computer model of the part.

10. A method comprising:
obtaining a three-dimensional discretized computer model of a part in a three-dimensional discretized design space comprising three-dimensional geometrical elements;
obtaining an inlet position of an inlet and an outlet position of an outlet for a non-branching cooling channel in a portion of the three-dimensional discretized design space;
producing a signed distance field based on a geometry of the three-dimensional discretized computer model of the part as represented in the three-dimensional geometrical elements of the three-dimensional discretized design space; and
generating the non-branching cooling channel in the portion of the three-dimensional discretized design space using a path search algorithm, the inlet position, the outlet position, and the signed distance field, wherein the non-branching cooling channel connects the inlet and the outlet.

11. The method of claim 10, wherein generating the non-branching channel comprises
producing a block map based at least in part on the signed distance field, wherein the block map comprises, for each three-dimensional geometrical element in the three-dimensional discretized design space, a value indicating whether the three-dimensional geometrical element is blocked.

12. The method of claim 11, wherein the block map indicates as blocked one or more of
i) three-dimensional geometrical elements with a value of the signed distance field lower than the specified distance value from the part,
ii) three-dimensional geometrical elements representing a parting plane or an ejector pin, or
iii) three-dimensional geometrical elements representing pre-existing cooling channels, and three-dimensional geometrical elements within a distance from the pre-existing cooling channel smaller than an inter-channel distance value.

13. The method of claim 11, wherein connecting the inlet and the outlet using the path search algorithm, the inlet position, the outlet position, and the signed distance field comprises using the path search algorithm and the block map to generate a shortest path between the inlet position and the outlet position that does not traverse any of the three-dimensional geometrical elements indicated as blocked.

14. The method of claim 11, wherein connecting the inlet and the outlet using the path search algorithm, the inlet position, the outlet position, and the signed distance field comprises connecting the inlet and the outlet using the path search algorithm and the block map to generate a path between the inlet position and the outlet position that circumvents the part and that does not traverse any of the three-dimensional geometrical elements indicated as blocked.

15. The method of claim 14, wherein connecting the inlet and the outlet using a path that circumvents the part further comprises:
indicating as blocked in the block map all the three-dimensional geometrical elements of the three-dimensional discretized design space that are located at a Z position that is farther than a predefined threshold from any of the inlet Z position and the outlet Z position; and
generating a virtual obstacle between the inlet and the outlet using the block map.

16. A method comprising:
generating, according to the method of claim 1, at least one non-branching channel in a first portion of the three-dimensional discretized design space corresponding to a mold cavity; and
generating, according to the method of claim 1, at least one non-branching channel in a second portion of the three-dimensional discretized design space corresponding to a mold core.

17. The method of claim 16 comprising
obtaining a three-dimensional discretized computer model of a mold for the part, the three-dimensional discretized model comprising the mold core and the mold cavity; and
obtaining a parting plane of the mold in the three-dimensional discretized design space, wherein the parting plane lies on an X-Y plane of the three-dimensional discretized design space.

18. A method comprising:
generating, according to the method of claim 10, at least one non-branching channel in a first portion of the three-dimensional discretized design space corresponding to a mold cavity; and
generating, according to the method of claim 10, at least one non-branching channel in a second portion of the three-dimensional discretized design space corresponding to a mold core.

19. The method of claim 18, wherein generating the at least one non-branching channel in the first portion of the three-dimensional discretized design space corresponding to the mold cavity and generating the at least one non-branching channel in the second portion of the three-dimensional discretized design space corresponding to the mold core comprises producing a block map based at least in part on the signed distance field, wherein the block map comprises, for each three-dimensional geometrical element in the three-dimensional discretized design space, a value indicating whether the three-dimensional geometrical element is blocked.

20. The method of claim 19, wherein the block map indicates as blocked one or more of
i) three-dimensional geometrical elements with a value of the signed distance field lower than the specified distance value from the part,
ii) three-dimensional geometrical elements representing a parting plane or an ejector pin, or
iii) three-dimensional geometrical elements representing pre-existing cooling channels, and three-dimensional geometrical elements within a distance from the pre-existing cooling channel smaller than an inter-channel distance value.
